(19) United States
(12) Patent Application Publication
(10) Pub. No.: US 2026/0079617 A1
(43) Pub. Date: Mar. 19, 2026

(54) SYSTEMS AND METHODS FOR ELECTRONIC DATA MANAGEMENT AND VISUALIZATION

(71) Applicant: Lee Labs, LLC, San Francisco, CA (US)

(72) Inventors: Albert LEE, Hillsborough, CA (US); Michael LEE, San Francisco, CA (US); Nicholas LAU, San Francisco, CA (US); Warren WAN, Pasadena, CA (US); Emily HOM-NICI, Brooklyn, NY (US); Ben MCALLISTER, Chapel Hill, NC (US)

(21) Appl. No.: 19/331,177

(22) Filed: Sep. 17, 2025

Related U.S. Application Data
(60) Provisional application No. 63/695,484, filed on Sep. 17, 2024.

(51) Int. Cl. G06F 3/04847; G06F 3/0485; G06F 9/451; G06Q 10/109

(52) U.S. Cl. CPC G06F 3/04847; G06F 3/0485; G06F 9/451; G06Q 10/109

(57) ABSTRACT

Systems and methods of managing an event on a data organizer application are disclosed. One method may include: receiving, using a processor associated with the data organization application, a selection from a user to transition an interface of an electronic data organizer of the data organizer application from a first view to a second view; identifying, using the processor, a type designation associated with each event contained in the electronic data organizer; and reorganizing, using the processor and based on the selection, a visual display of each event of the interface to correspond with the second view as dictated by the type designation.

### CROSS REFERENCE TO RELATED APPLICATION

The application claims priority to U.S. Provisional Application No. 63/695,484, filed on Sep. 17, 2024, which is incorporated by reference herein in its entirety.

### TECHNICAL FIELD

The present disclosure relates generally to the field of data analytics, management, and visualization and, more particularly, to systems and methods for leveraging electronic data organization tools to enable context-specific data presentation.

### BACKGROUND

The prevalence of electronic data organization tools in modern society, such as electronic calendars, has transformed the way that individuals manage their time and commitments. However, the existing landscape of calendar systems present a number of inherent challenges, especially as individuals navigate between multiple calendars for work, personal, and family obligations. For instance, one significant challenge encountered by many users is the lack of comprehensive views that allow for efficient organization and visualization of commitments over specific timeframes, such as over weekends and months. Traditional electronic calendars provide limited functionality in this regard, resulting in fragmented scheduling and potential oversights.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are provided for optimized data visualization within calendar systems.

In one aspect, a computer-implemented method for managing an event on a data organizer application is disclosed. The computer-implemented method may include: receiving, using a processor associated with the data organizer application, a selection from a user to transition an interface of an electronic data organizer of the data organizer application from a first view to a second view; identifying, using the processor, a type designation associated with each event contained in the electronic data organizer; and reorganizing, using the processor and based on the selection, a visual display of each event of the interface to correspond with the second view as dictated by the type designation.

In another aspect, a computer system is disclosed. The computer system may include: at least one processor; at least one memory storing instructions that are executable by the at least one processor, wherein the instructions cause the at least one processor to: receive a selection from a user to transition an interface of an electronic data organizer of a data organizer application from a first view to a second view; identify a type designation associated with each event contained in the electronic data organizer; and reorganize, based on the selection, a visual display of each event of the interface to correspond with the second view as dictated by the type designation.

In yet another aspect, a non-transitory computer-readable medium storing instruction for managing an event on a data organizer application is disclosed. The non-transitory computer-readable medium may store instructions that, when executed by at least one processor, cause the at least one processor to perform operations including: receiving a selection from a user to transition an interface of an electronic data organizer of the data organizer application from a first view to a second view; identifying a type designation associated with each event contained in the electronic data organizer; and reorganizing, based on the selection, a visual display of each event of the interface to correspond with the second view as dictated by the type designation.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of any embodiment will be pointed out in the appended claims.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 depicts an exemplary system infrastructure for executing the techniques described herein, according to one or more embodiments of the present disclosure.

FIG. 2 depicts an exemplary slider, according to one or more embodiments of the present disclosure.

FIG. 3 depicts an exemplary calendar situated in month view, according to one or more embodiments of the present disclosure.

FIG. 4 depicts another exemplary calendar situated in month view, according to one or more embodiments of the present disclosure.

FIGS. 5A and 5B depict event containers, according to one or more embodiments of the present disclosure.

FIG. 6 depicts another exemplary calendar situated in month view, according to one or more embodiments of the present disclosure.

FIG. 7 depicts an exemplary mini-calendar, according to one or more embodiments of the present disclosure.

FIG. 8 depicts an exemplary daily event summary popover, according to one or more embodiments of the present disclosure.

FIG. 9 depicts an exemplary event details popover, according to one or more embodiments of the present disclosure.

FIG. 10 depicts an exemplary calendar situated in day view, according to one or more embodiments of the present disclosure.

FIGS. 11A and 11B depict exemplary calendar days, according to one or more embodiments of the present disclosure.

FIG. 12 depicts an exemplary popover, according to one or more embodiments of the present disclosure.

FIGS. 13A and 13B depict two exemplary scheduling situations, according to one or more embodiments of the present disclosure.

FIG. 14 depicts another exemplary scheduling situation, according to one or more embodiments of the present disclosure.

FIG. 15 depicts an exemplary calendar illustrating a multi-day event, according to one or more embodiments of the present disclosure.

FIG. 16 depicts an exemplary navigation pane, according to one or more embodiments of the present disclosure.

FIG. 17 depicts an exemplary mini-calendar, according to one or more embodiments of the present disclosure.

FIG. 18 depicts an exemplary calendar portion situated in month view, according to one or more embodiments of the present disclosure.

FIG. 19 depicts another exemplary calendar portion, according to one or more embodiments of the present disclosure.

FIG. 20 depicts an exemplary popover, according to one or more embodiments of the present disclosure.

FIG. 21 depicts an exemplary calendar containing event display toggles, according to one or more embodiments of the present disclosure.

FIG. 22 depicts an exemplary calendar situated in week view, according to one or more embodiments of the present disclosure.

FIG. 23 depicts scrolling functionality of an exemplary calendar situated in week view, according to one or more embodiments of the present disclosure.

FIG. 24 depicts a weekend view within an electronic calendar application, according to one or more aspects of the present disclosure.

FIG. 25 depicts a view slider within the top navigation area of an electronic calendar application, according to one or more aspects of the present disclosure.

FIGS. 26A and 26B depict an interactive use case of a view slider within the top navigation area of an electronic calendar application, according to one or more aspects of the present disclosure.

FIG. 27 depicts a weekend view within an electronic calendar application, according to one or more aspects of the present disclosure.

FIGS. 28A and 28B demonstrate the interactive functionality of hovering over unselected weekends within the weekend view of an electronic calendar application, according to one or more aspects of the present disclosure.

FIG. 29 demonstrates how a selected weekend may be visually distinguished within the weekend view of an electronic calendar application, according to one or more aspects of the present disclosure.

FIG. 30 depicts the functionality of transitioning from a selected weekend view into a four-day detailed view, according to one or more aspects of the present disclosure.

FIG. 31 depicts a toast notification displayed to a user upon transitioning from a weekend view into a four-day view, according to one or more aspects of the present disclosure.

FIG. 32 depicts a mini-calendar associated with the weekend view of an electronic calendar application, according to one or more aspects of the present disclosure.

FIG. 33 demonstrates the interactive functionality of selecting a weekend from the mini-calendar in connection with the weekend view of the electronic calendar application, according to one or more aspects of the present disclosure.

FIG. 34 demonstrates synchronization between the main calendar canvas and the mini-calendar in an electronic calendar application, according to one or more aspects of the present disclosure.

FIG. 35 depicts how tags may be displayed in the mini-calendar 3505 when operating in weekend view, according to one or more aspects of the present disclosure.

FIG. 36 demonstrates the functionality of a month picker drop-down in association with the mini-calendar of the weekend view, according to one or more aspects of the present disclosure.

FIG. 37 demonstrates how tags may be incorporated into the month picker drop-down to assist users in quickly locating months with relevant tagged events, according to one or more aspects of the present disclosure.

FIGS. 38A and 38B demonstrate the ability for users to selectively show or hide work events within the weekend view of the electronic calendar application, according to one or more aspects of the present disclosure.

FIG. 39 demonstrates the holiday event treatment within the weekend view of an electronic calendar application, according to one or more aspects of the present disclosure.

FIG. 40 depicts how the system may visually treat “Today” and “New Month” indicators within the weekend view of an electronic calendar application, according to one or more embodiments of the present disclosure.

FIG. 41 depicts an example of a computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “about,” and “generally,” are used to indicate a possible variation of +10% of a stated or understood value.

As used herein, the term “information handling device” generally encompasses virtually any type of electronic computing device including, for example, laptop and/or personal computers, smart phones, tablet devices, wearable devices, hybrid devices, other types of user devices, and the like. The term “information handling device” may be used interchangeably with, or in place of, any or all of the aforementioned types of computing devices. Additionally, utilization of one of the foregoing terms over another may not be intended to be limiting unless explicitly designated as such.

In contemporary society, the reliance on data organization tools, such as electronic calendars, has become indispensable for managing time and commitments. However, a universal challenge persists as individuals contend with the complexity of juggling multiple calendars and/or single calendars that are filled with an overabundance of information. Conventional calendar systems, while widely adopted, are inherently limited in their ability to seamlessly integrate disparate commitments and to intelligently manage the volume and types of information that are displayed, thereby leading to inefficiencies in time management and attention allocation.

Weekends, being critical planning units for various activities (e.g., leisure events, family activities, etc.), are often not visually represented in alignment with user's conceptualization of them as discrete chunks of time. For instance, conventional calendar systems typically split Saturday and Sunday across different calendar views, thereby leading to disjointed representations of weekend commitments. This issue is also prevalent in holiday situations, where traditional calendar systems may not effectively highlight weekends connected to national holidays or school days off, making it challenging for users to plan trips or avoid crowded periods. Furthermore, the evolving nature of weekend dynamics, particularly in hybrid or work-from-home settings, poses challenges in accurately representing the flexibility and variability of weekend schedules. More particularly, traditional calendar views may fail to capture the interconnectedness of commitments spanning Friday through Monday, leading to potential scheduling conflicts and oversights. Additionally, users may encounter challenges in quickly identifying available weekends for planning activities or events. Conventional calendar systems may lack features that allow users to easily scan through weekends and identify free time slots without the need for manual inspection. This issue extends to the coordination of trips or events involving multiple household members, which may be cumbersome in traditional calendar views because users struggle to view the entire household's schedule at once.

With respect to month views, traditional electronic calendars often offer static month views that may not adequately represent commitments spanning multiple days or weeks. Users may struggle to visualize long-term schedules or identify patterns and conflicts within a month due to limited customization options and inflexible display formats. Furthermore, the dynamic nature of month-to-month variations in commitments, e.g., such as a holidays, events, deadlines, etc., may not be effectively captured in traditional calendar systems. Specifically, users may find it challenging to prioritize and plan activities within a month without clear visibility into notable events or time-sensitive tasks. Additionally, similar to issues with weekend views, users may encounter difficulties when using traditional calendar systems in quickly identifying available time slots within a month for scheduling new activities or events. This may cause challenges in the planning of trips, vacations, or other activities due to unclear visibility into relevant contextual information within the calendar interface. Furthermore, navigating between different months within a traditional calendar interface may be cumbersome and time-consuming. Specifically, users may experience difficulties in switching between monthly views, accessing historical or future months, or identifying trends and patterns across different timeframes.

In response to the challenges outlined above, the present disclosure is accordingly directed to systems and methods that enhance the representation and usability of period-specific views within electronic calendars. For instance, with respect to weekend and month views, embodiments of the disclosure provide detailed event listings and summary information for each weekend and present users with unique controls that enable them to efficiently navigate through one or more calendars. Embodiments of the disclosure may also employ artificial intelligence (AI), e.g., as embodied by one or more trained machine learning models, to assist in the identification of time periods that one or more events may be scheduled in.

The methods and systems described herein represent a variety of technical improvements to computer technology, in the field of data analytics, data management, and data visualization. For instance, by providing dedicated weekend and month views with dynamic event organization and customizable display options, the concepts enhance users' ability to efficiently manage their time and commitments. More particularly, presenting users with only the information they need at any given time streamlines the user interface and improves usability. Specifically, by eliminating clutter and noise, users can focus on critical tasks more effectively, leading to a more satisfying and productive user experience.

Additionally to the foregoing, computational resources may be optimized by only providing relevant information related to context-specific time periods of user interest. For instance, filtering out or de-emphasizing (e.g., by graying out, etc.) irrelevant or unnecessary information (e.g., background events that a user does not plan to attend, events that are outside of a time period of interest, etc.) may conserve computational resources as the system processes and displays only the data pertinent to the user's current context. This reduces the computational load on servers and client devices, leading to improved performance and responsiveness. In the same vein, retrieving only relevant information from a calendar database may minimize the amount of data transferred between servers and client devices. This results in faster data retrieval times, reduced network bandwidth usage, and improved overall system efficiency.

Furthermore, the dynamic nature by which various graphical user interface (GUI) icons and/or visual elements associated with the electronic calendar are represented may exemplify a specific improvement over conventional systems. Specifically, the amount of information, and the way in which that information is presented, over certain periods of time (e.g., during a particular week in a month, during a particular weekend in the month, etc.) may dynamically be adjusted based upon user inputs or new calendar events. These dynamic GUI adjustments require the use of a processor and cannot be practically applied in the human mind. Additionally, these unique GUI traits result in an improved user interface for electronic devices that implement the electronic calendar.

The concepts in commonly owned U.S. patent application Ser. No. 18/671,255, filed on May 22, 2024, are incorporated by reference herein. More particularly, some aspects of the present disclosure may leverage one or more of the “layering,” “tags,” “lenses,” “rules,” and “smart metrics” features described in the foregoing application.

The subject matter of the present disclosure will now be described more fully hereinafter with reference to the accompanying drawings, which form a part hereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof. The following detailed description is, therefore, not intended to be taken in a limiting sense.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

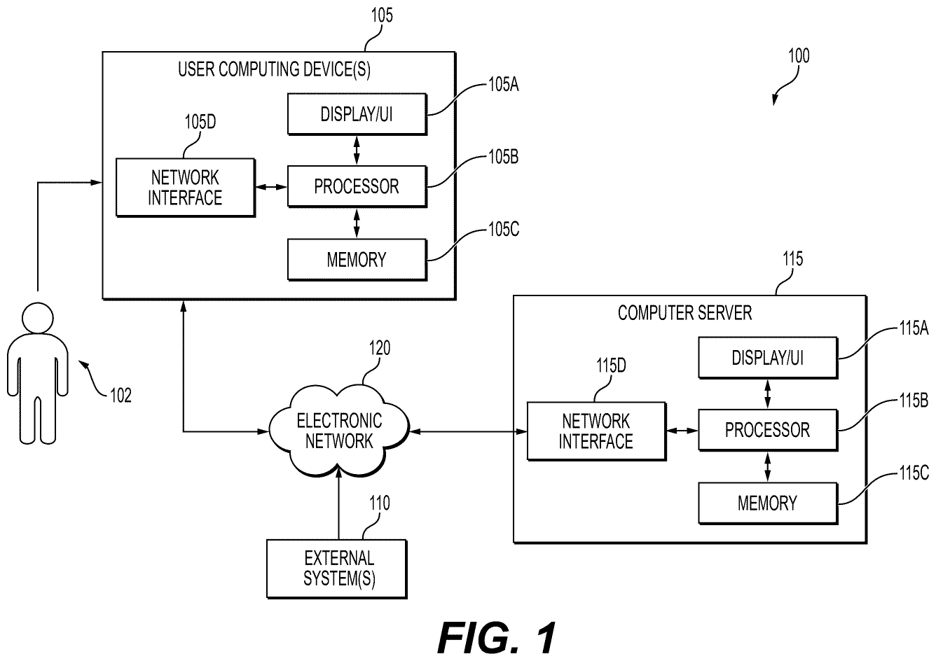

FIG. 1 depicts an exemplary system environment 100 for event visualization that may be utilized with techniques presented herein. A user computing device 105, an external system(s) 110, and a computer server 115 may communicate across a network 120. The user computing device 105 may be associated with a user 102, e.g., a user that interacts with one or more of their electronic data organizers (also referred to herein as calendars, electronic calendars, or the like). The external system(s) 110 may be associated with one or more entities that may store and/or communicate data relevant to the user. For example, the external system(s) 110 may be another email or communication platform, a social media platform, another data store containing other types of user information, and the like.

The user computing device 105, the external system 110, and the computer server 115 may be connected via network 120, e.g., using one or more standard communication protocols. The network 120 may comprise one or more networks that connect devices and/or components of system environment 100 to allow communication between the devices and/or components. For example, the network 120 may be implemented as the Internet, a wireless network, a wired network (e.g., Ethernet), a local area network (LAN), a Wide Area Network (WANs), Bluetooth, Near Field Communication (NFC), or any other type of network that provides communications between one or more components of environment 100. In some embodiments, the network 120 may be implemented using cell and/or pager networks, satellite, licensed radio, or a combination of licensed and unlicensed radio. The network 120 may be associated with a cloud platform that stores data and information related to methods disclosed herein.

In some embodiments, network 125 includes the Internet, and information and data provided between various systems occurs online. “Online” may refer to connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As shown in FIG. 1, the computer server 115 may be in communication with the user computing device 105 to transmit and receive messages, instructions, and/or other data from each other across the network 120. The user computing device 105 may be associated with a user that is utilizing a data organizer application, such as an email and/or calendaring application, provided by the computer server 115. The computer server 115 may be configured to receive data over the network 120 from the user computing device 105, e.g., new event creations, event modifications, responses to event requests, calendar settings adjustments, etc., and from external system(s) 110, e.g., context data associated with the user such as user availability, user location, user preferences, etc. In some embodiments, the computer server 115 may be a server cluster, or any other collection or network of a plurality of computer servers.

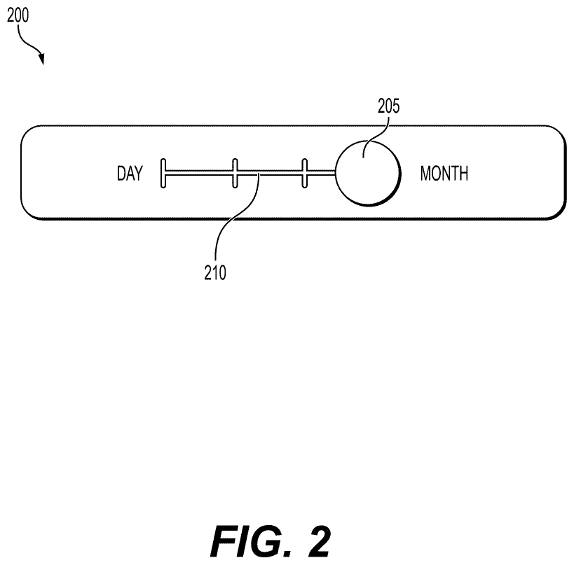

The user computing device 105 may include a display/user interface (UI) 105A, a processor 105B, a memory 105C, and/or a network interface 105D. The user computing device 105 may be a personal computer (PC), a tablet PC, a streaming device, a smart TV, a gaming console, a personal digital assistant (PDA), a mobile device, a palmtop computer, a laptop computer, a desktop computer, or any other information handling device capable of accessing and utilizing features of a calendaring application as described herein. The user computing device 105 may execute, by the processor 105B, an operating system (O/S) and at least one application (each stored in memory 105C). The application may be a browser program or a mobile application program (which may also be a browser program in a mobile O/S). The application may generate one or more interactive graphic user interfaces (GUIs) and/or graphical elements, such as, for example, the exemplary GUIs and elements shown in FIGS. 2-20, based on instructions/information received from the server 115. In some embodiments, the application may generate one or more interactive GUIs based on instructions/information stored in the memory 105C. The interactive GUIs may be application GUIs for the application executed based on XML and Android programming languages or Objective-C/Swift, but one skilled in the art would recognize that this may be accomplished by other methods, such as webpages executed based on HTML, CSS, and/or scripts, such as JavaScript. The display/UI 105A may be a touch screen or a display with other input systems (e.g., mouse, keyboard, etc.). The network interface 105D may be a TCP/IP network interface for, e.g., Ethernet or wireless communications with the network 120. The processor 105B, while executing the application, may receive user inputs from the display/UI 105A, and perform actions or functions in accordance with the application.

External system(s) 110 may be, for example, one or more third-party and/or auxiliary systems that integrate and/or communicate with the server systems 115, 120 in performing various user access control tasks. For example, the external system(s) may include an identity provider that may be configured to validate user login credentials (e.g., by comparison of the user login credentials to a credential database 110A) and issue identity (ID) tokens, as further described herein. External systems 110 may be in communication with other device(s) or system(s) in the environment 100 over the one or more networks 120. For example, external system(s) 110 may communicate with the authorization server 115 via API (application programming interface) access over the one or more networks 120, and may also communicate with the user device(s) 105 via web browser access over the one or more networks 120.

The computer server 115 may include a display/UI 115A, a processor 115B, a memory 115C, and/or a network interface 115D. The server 115 may be a computer, system of computers (e.g., rack server(s)), and/or or a cloud service computer system. The server 115 may execute, by the processor 115B, an operating system (O/S) and at least one instance of a server program (each stored in memory 115C). The server 115 may store or have access to information from external system(s) 120. The display/UI 115A may be a touch screen or a display with other input systems (e.g., mouse, keyboard, etc.) for an operator of the server 115 to control the functions of the server 115 (e.g., update the server program and/or the server information). The network interface 115D may be a TCP/IP network interface for, e.g., Ethernet or wireless communications with the network 120. Computer server 115 may store data associated with user 102 of user computing device 105. For instance, computer server 115 may store contact information for other individuals user 102 is associated with, settings data for one or more calendars used by user 102, event data associated with the one or more calendars, and the like. Additionally or alternatively, computer server 115 may store additional data received from user computing device 105 including real time and/or near real time location data (e.g., GPS data) of the user computing device 105.

### Month View

Many conventional digital calendars provide a traditional month view that displays only basic information such as event titles or icons. This limited visibility makes it challenging for users to quickly understand their schedules and commitments for the entire month at a glance. Additionally, in an attempt to fit as much information as possible, some calendar applications overcrowd the month view with numerous events and appointments, leading to a cluttered interface. This may make it difficult for users to differentiate between different events and priority their time effectively. Furthermore, conventional calendar applications generally lack robust filtering options in the month view. Because of this, users may struggle to filter events based on specific criteria such as event type, location, or importance, thereby making it challenging to focus on relevant information and plan their schedules accordingly.

To address some or all of the foregoing issues, this section introduces an improved month view that provides users with a comprehensive overview of an entire month's schedule and commitments. Unlike conventional calendars, the month view associated with the underlying concepts prioritizes enhanced visibility and organization, thereby enabling users to quickly grasp their schedules for the entire month at a glance. Furthermore, the improved month view offers robust filtering options and customization features, allowing users to tailor the month view according to their preferences and needs. Additionally, unlike conventional calendars with limited interactivity, the improved month view prioritizes interactive functionality within the month view. Additionally still, the improved month view employs visual cues and customization options to facilitate efficient event identification within the month view. Specifically, important events may be highlighted using color-coding schemes or distinct visual elements, ensuring they stand out amidst other events and priorities.

The remaining sections of this application refer to colored elements of the calendaring interface. In the accompanying black-and-white drawings, these elements are visually distinguished using patterns, shading, and other graphical techniques to represent the respective colors. Even though the current disclosure describes color-coding as one way to visually differentiate the elements from one another, other techniques may also be used, such as varying patterns, line styles, or other graphical indicators.

Referring now to FIG. 2, an exemplary slider 200 is presented that serves as a navigational tool within an electronic calendar application that may enable a user to transition between different calendar views. In the context of this application, a calendar view may correspond to a calendar display mode that dictates how, and what types of, calendaring information are presented to the user. For instance, a user may select between a day view, a weekend view, a month view, etc., whereby each view type is configured to present information a specific way. Users may interact with slider 200 by moving toggle 205 horizontally along track 210. When toggle 205 is moved to a different view type (e.g., switched between day view to month view), it triggers a transition from a detailed, time-specific view to a broader, month “at-a-glance” perspective. Slider 200 may be positioned virtually anywhere on the calendaring interface, e.g., in the top navigation bar. The inclusion of slider 200 in the electronic calendar application enhances user control over the calendar interface, allowing users to tailor their viewing experience based on their preferences and current needs.

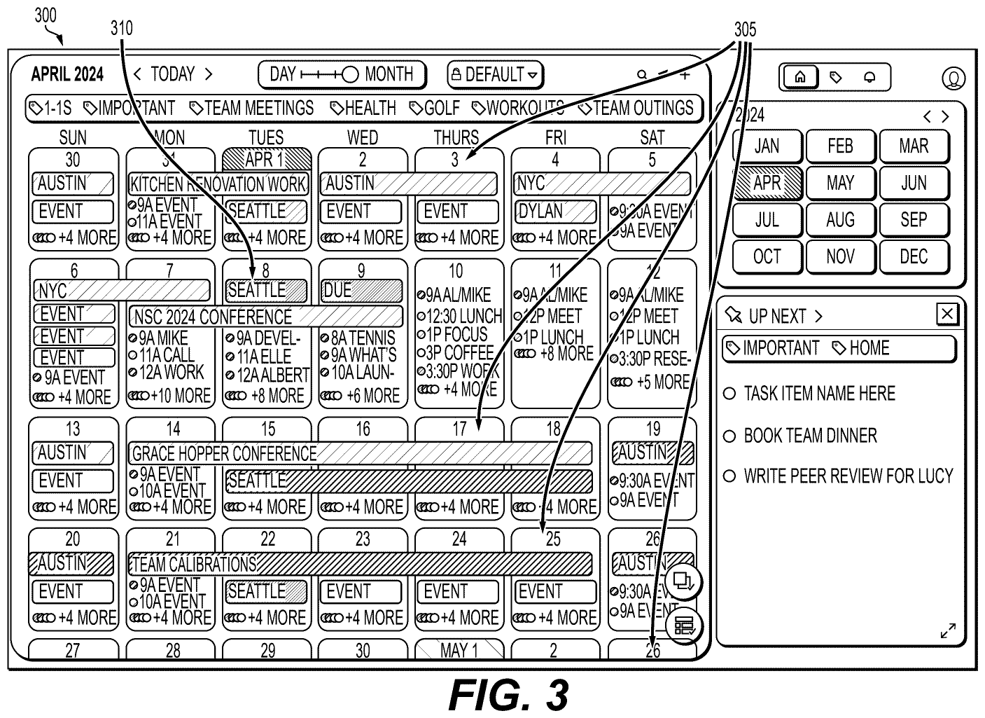

Referring now to FIG. 3, an exemplary calendar 300 is presented that is situated in month view. Within this view type, there may be standard 305 and expanded 310 week rows, which are two different display formats used within the electronic calendar application to present weekly schedules. With respect to the former, standard week rows 305 represent one week's worth of events within the calendar view. These rows typically display events from Sunday to Saturday, following the conventional layout of a weekly calendar. In an aspect, standard week rows 305 may have a standard height, allowing for a limited number of events to be displayed within each row. The number of displayed events in standard week rows 305 may vary based on the available screen size and resolution. Standard week rows 305 are suitable for providing a condensed overview of weekly commitments without overwhelming the user with too much information at once.

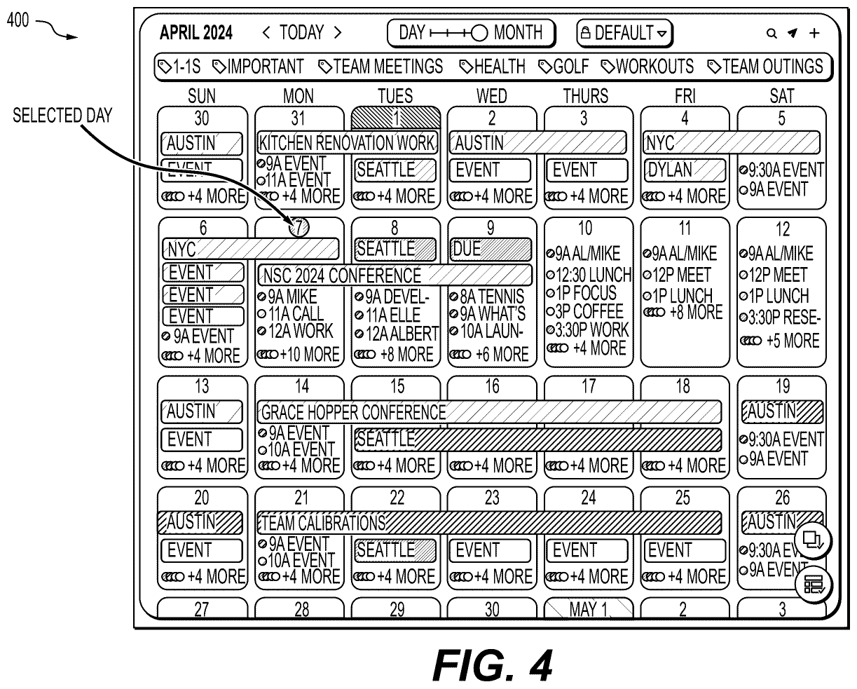

Expanded week rows 310 serve as an alternative display format that offers additional vertical space to accommodate more events within the calendar view. These rows 310 are taller than standard week rows 305, allowing for a greater number of events to be displayed vertically. Expanded week rows 310 may be activated or expanded upon user interaction, such as hovering over the row border or clicking on a specific control. The expanded format enables users to view more detailed information about events within a specific week without needing to navigate to individual days. By providing more vertical space, expanded week rows 310 facilitate a more comprehensive overview of weekly commitments, especially when dealing with busy schedules or overlapping events. In an aspect, a week row containing a “selected day” may itself be expanded. For instance, referring now to FIG. 4, exemplary calendar 400 illustrates that the week row containing the selected day will become the initial expanded week row in month view. If a day is not explicitly selected by the user, then the system may utilize the current day as the selected day by default.

In an aspect, the calendaring application may be configured to not always display a full single month at one time. Rather, the calendaring application may display as many week rows as possible, depending on screen size and/or resolution. In this regard, a minimum of one single week row may be displayed if the screen size is very small. Correspondingly, there is no maximum number of week rows that may be displayed if the screen size may support the information. In an aspect, the initial expanded week row (i.e., the row containing the selected day) may appear at the top of the calendar canvas. For example, if the selected day is on the 15^{th} of April, the calendaring application may display the expanded week row containing the 15^{th} of April at the top of the calendar canvas, rather than start at the 1^{st} of April, as is done in conventional calendaring systems. In an aspect, the calendaring application may be configured to display at least 5 weeks at one time, if possible, and each week row may be subject to the following default parameters: standard week rows may contain a maximum of 4 event lines per day whereas the expanded week row may contain a maximum of 9 event lines per day. If the system determines that the screen size is large enough to support adding more event lines to each week row, the additional lines may be added based on the following rules: 2 event lines may be added to each standard week row for every 1 event line added to the expanded week row until the regular week row reaches the maximum of 11 event lines, and the expanded week row reaches the maximum of 14 event lines. In an aspect, once the maximum event lines are reached for the initial 5 weeks, and there is still room to display additional information, additional future weeks may be added based on the following rules: each new week should be added with the same number of event lines as the other weeks in the view.

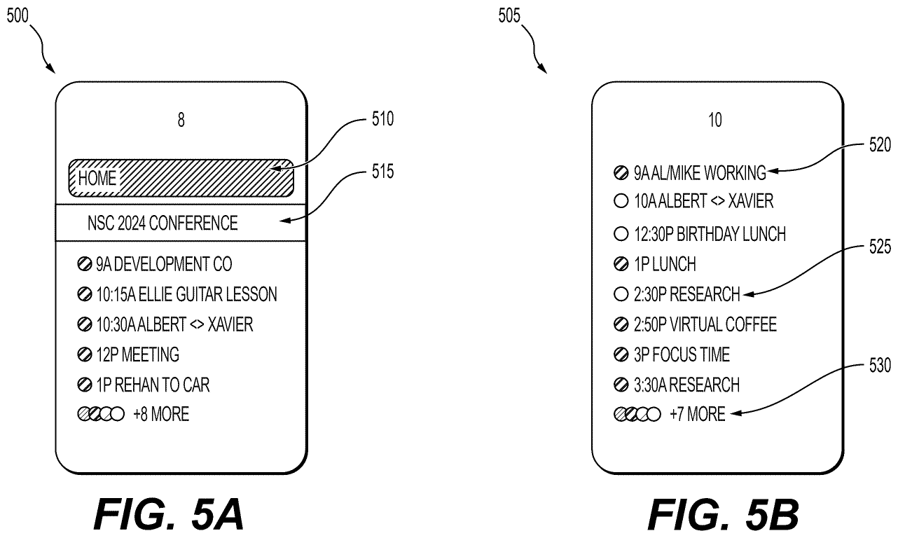

Referring now collectively to FIGS. 5A and 5B, event container 500 and 505 are illustrated according to an embodiment. In an aspect, an event container represents a visual space (e.g., often associated with a single calendar day) that is responsible for displaying a list of user events. Specifically, the event container serves as a designated area where events are organized and presented to users within the calendar view. It provides a structured layout for displaying various types of events, including all-day events and timed events. For instance, standard week rows may have a minimum of 4 event lines and expanded week rows may have a minimum of 9 event lines.

In an aspect, events are arranged within the container based on their scheduled time and date, allowing users to easily visualize their commitments over a specified period. For instance, referring first to FIG. 5A, within the event container 500, all-day events 510, 515 may be displayed first. In an aspect, all-day events generally occupy the entire duration of a day and are usually represented by banners or blocks spanning across the corresponding day or days. Additionally, with respect to event order, commitment events may be displayed before awareness events. In an aspect, commitment events are time-specific engagements that users have committed to attending or participating in. These events may include meetings, appointments, deadlines, or other scheduled activities with fixed start and end times. Awareness events represent events or reminders that users want to be aware of but are not committing to attend or complete. These events may include tasks, reminders, or other activities. As an example of the foregoing, FIG. 5A shows that the all-day event “home” 510 is presented before the commitment event “NSC 2024 Conference” 515. In an aspect, all-day events may be extended to multiple days by clicking and dragging either end of the event. These events may be extended as far into the past or future as the user desires, so long as there are no rendering issues on the calendar canvas.

Timed events may be presented within the event container after the all-day events. The timed events may be listed in chronological order, with their start and end times indicated alongside event titles. These events may appear as bullet points, bars, or other graphical elements, depending on the calendar's visual design. In an aspect, if a timed event starts on the hour, just the first number of the event may be displayed (e.g., 7a or 7p). Alternatively, if the timed event starts past the hour, the full time may be displayed (e.g., 9:30a or 9:45 pm). In some implementations, the letter “a” may represent “AM” and the letter “p” may represent “PM.” FIGS. 5A and 5B each contain a list of timed events, a subset of which are highlighted in FIG. 5B as 520 and 525.

In an aspect, all-day events and timed events may be moved to different days. Users may initiate the event movement process by selecting the event they want to move within the calendar interface. This action may involve clicking or tapping on the event to activate it for movement. Once the event is activated for movement, users may utilize a drag-and-drop interaction to relocate the event to a different date, time slot, or location within the calendar grid. During the drag-and-drop interaction, the calendar application may provide visual feedback to indicate the new position of the event as it is being moved. This may include highlighting the target date or time slot where the event will be placed once the user releases the mouse button or lifts their finger. In an aspect, as the user moves the event within the calendar interface, the application updates the event's date, time, and position in real-time to reflect the changes. This allows users to preview the new schedule and ensure that it meets their requirements before finalizing the movement. In an aspect, once the event is moved to the desired location, users can release the mouse button or lift their finger to confirm the movement. The calendar application may prompt users to confirm the changes or provide a visual indication that the event has been successfully relocated.

In cases where there are more events than can be displayed within the available space of the event container, overflow handling mechanisms may be employed. For instance, this may involve indicating the presence of additional events beyond the visible area and providing options for users to access or expand the event list. For example, the last event entry in FIGS. 5A and 5B represents an overflow listing 530, in which the number of events that are unable to be listed are grouped. A user may be able to access the events in this overflow by selecting the “X more” portion of overflow listing event.

In an aspect, the event container may incorporate interactive elements to allow users to interact with events, such as clicking or tapping to view event details, editing event information, or creating new events directly within the calendar interface.

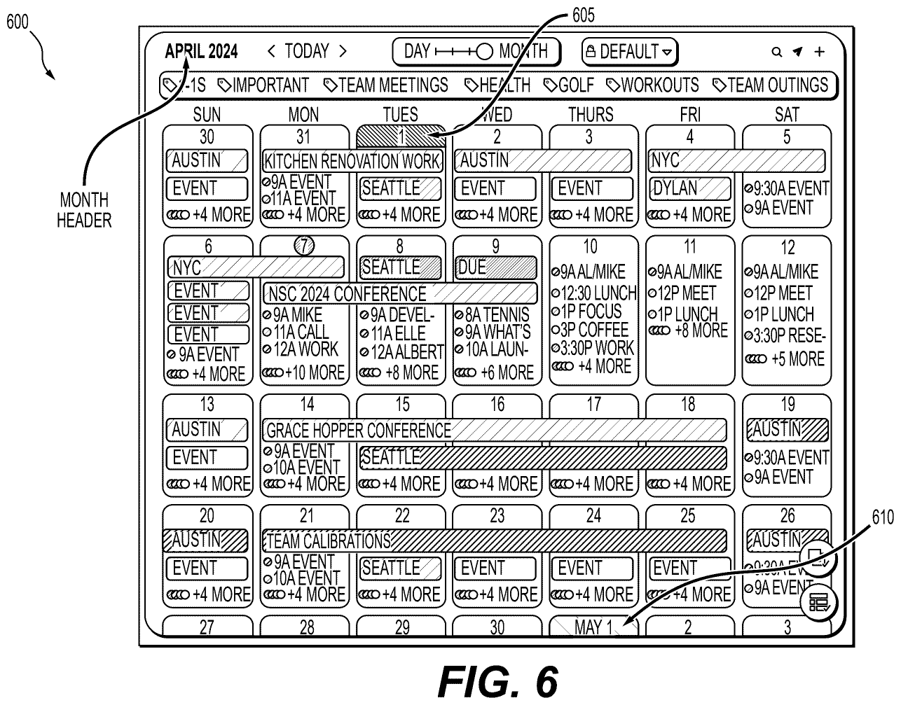

Referring now to FIG. 6, exemplary calendar 600 is illustrated to highlight the utilization of month indicators. In an aspect, month indicators may be visual cues or markers within the electronic calendar application that help users identify and navigate between different months. In an aspect, month indicators may typically be applied to specific dates within the calendar view, typically the first day of each month. These dates are highlighted or styled differently from other days to draw attention to the beginning of a new month. For instance, month indicators often include visual elements such as the name of the month displayed next to the date, highlighting the transition to a new month. Additionally or alternatively to textual cues, month indicators may utilize color coding to further differentiate the selected month from others. The header color for the selected month may stand out in contrast to past and future months, making it easier for users to locate and focus on the current month. For example, calendar 600 in FIG. 6 applies a first visual effect to a selected month 605 (e.g., represented by tight diagonal hashing) and may apply a second visual effect to a future month 610 (e.g., represented by broad diagonal hashing).

The electronic calendar of the embodiments may be configured to enable different types of user scrolling. For instance, the calendaring application may enable vertical scrolling, which allows users to navigate through different time periods within a specific calendar view. In month view, vertical scrolling typically enables users to move between different months by scrolling up or down. This allows users to explore past and future months without switching to a different view. The calendar interface may include scroll bars or may be configured to support touch gestures (e.g., swiping up or down on a touchscreen device) to facilitate vertical scrolling. In another aspect, horizontal scrolling enables users to navigate through consecutive time periods within a single calendar view, such as moving between days or weeks. In day or week view, horizontal scrolling allows users to move forward or backward in time, viewing events for different days or weeks within the current view. In another aspect, some calendar applications may support infinite bi-directional scrolling. Such a feature may allow users to continuously navigate through time periods in both forward and backward directions. With infinite scrolling, users can seamlessly explore past and future dates without encountering any interruptions or page boundaries. This feature provides a fluid and uninterrupted navigation experience, enabling users to navigate through their schedules with ease.

In an aspect, as users scroll through different time periods, the calendar interface may dynamically update to display the corresponding dates and events. For example, when scrolling to view future months in month view, the calendar interface may update to show the upcoming month's date and events. Dynamic date updates ensure that users maintain context as they navigate through different time periods, allowing for a smooth and intuitive user experience.

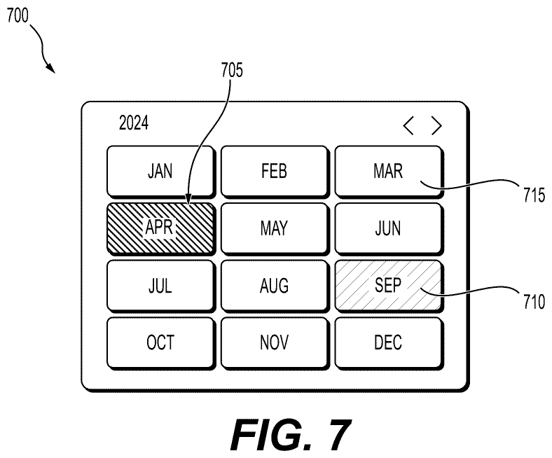

Some calendar interfaces may include a mini calendar view that provides an overview of the entire month or year, such as exemplary mini-calendar 700 presented in FIG. 7. More particularly, the mini calendar may be a compact representation of the calendar view that provides users with an overview of dates within a specified timeframe, typically a month or a year. It may appear as a small widget or panel within the calendar interface, allowing users to access it conveniently without obstructing the main content. Depending on the context and user preferences, the mini calendar may display either a monthly view or a yearly view. In a monthly view, individual days of the month are visible, while in a yearly view, entire months are displayed at once. For instance, mini-calendar 700 presents a yearly view, in which a current month 705 is visually distinguished using a first distinguishing technique and a selected month 710 is visually distinguished using a second distinguishing technique. Months that have already occurred in the yearly view, e.g., Month 715, may be visually de-emphasized (e.g., by graying out).

Users may interact with the mini-calendar to quickly navigate to specific dates or time periods within the main calendar view. Specifically, users may interact with the mini calendar to select a desired date or month, which then updates the main calendar display accordingly. In an aspect, scrolling navigation may also be synchronized between the main calendar view and the mini-calendar, allowing users to maintain consistency across different views.

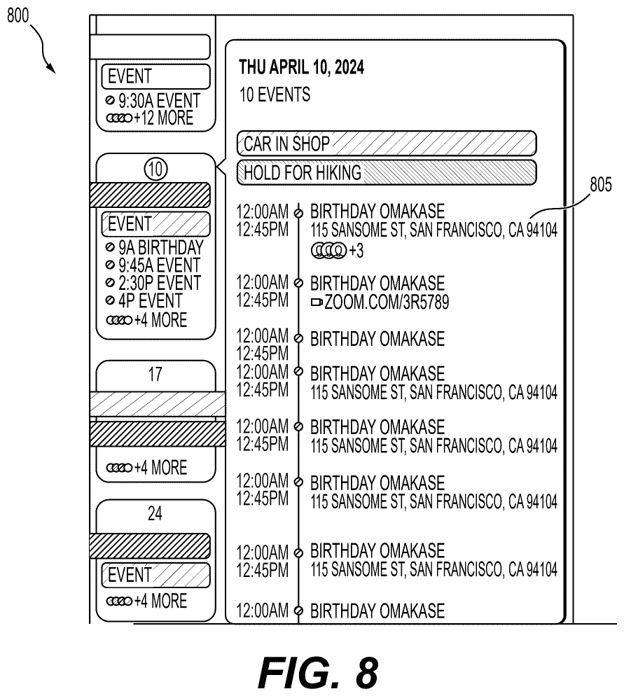

Referring now to FIG. 8, an exemplary daily events summary popover 800 is provided. The daily event summary popover (“popover”) may be a user interface element within the electronic calendar application that provides users with a concise overview of events scheduled for a specific day. In an aspect, the popover may appear when a user interacts with a specific date or day within the calendar interface, such as clicking or tapping on the day of the week number or the “X more” indicator for timed events. The popover may contain relevant information about the events scheduled for the selected day, organized into sections for better readability. The header of the popover may contain the date of the selected day and the total number of events scheduled for that day, providing users with context about the content within the popover. The popover may contain an all-day events section, which lists the all-day events scheduled for the selected day, displaying the title of each event. The popover may further contain a timed events section, which presents a chronological list of scheduled events with specific start and end times. Each event entry includes details such as the event title, start and end times, location, and participants. In an aspect, commitment events and awareness events may be visually distinguished within the popover using specific indicators, such as colored dots or icons, to help users differentiate between different types of events. In an aspect, the popover may be scrollable, allowing users to view all events scheduled for the selected day, especially if there are numerous events, or if event details extend beyond the popover's initial size.

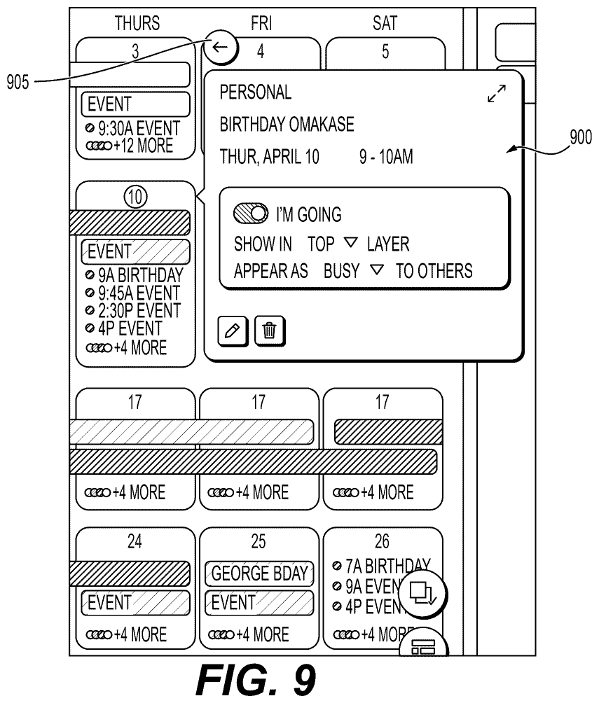

Users may interact with the individual events presented in the popover (e.g. by tapping on them) in order to access more detailed information about the event or to navigate to the corresponding event within the main calendar view. For instance, if a user selected timed event 805 (i.e., “Birthday Omakase”), then the event details for that event may appear (e.g., by an animation effect in which the event details animate in from right to left to replace the popover 800), as illustrated by event details popover 900 in FIG. 9. In an aspect, a user may interact with a back button 905 presented in associated with event details popover 900 to navigate back to popover 800.

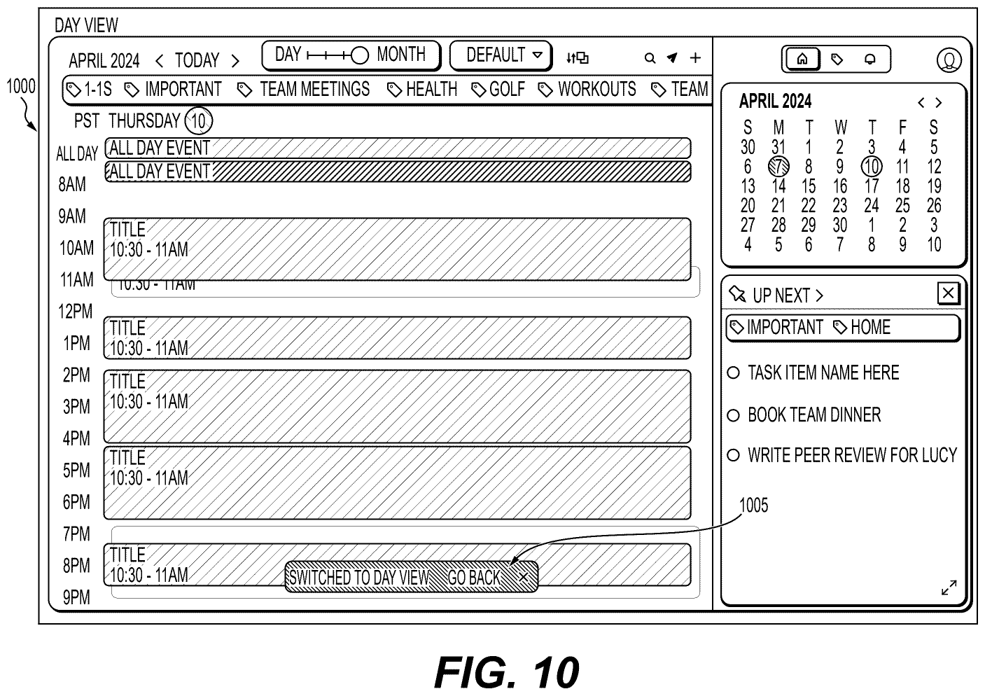

Referring now to FIG. 10, an exemplary illustration of a day view 1000 is provided. Such a view may provide users with a detailed and focused representation of events scheduled for a specific day. To enter day view from the month view, users may double-click or tap on the day of the week number in any row or the date at the top of the popover presented in FIG. 8. In an aspect, when day view is entered, an action box 1005 may be persistently co-displayed with the day view to enable a user to navigate away from the day view and/or back to the month view (e.g., by selecting a “back” option in action box 1005). In an aspect, just as in day view or week view, if a user double-clicks or taps directly onto any all-day event or timed event from the month view, they a standard popover of the event details may appear.

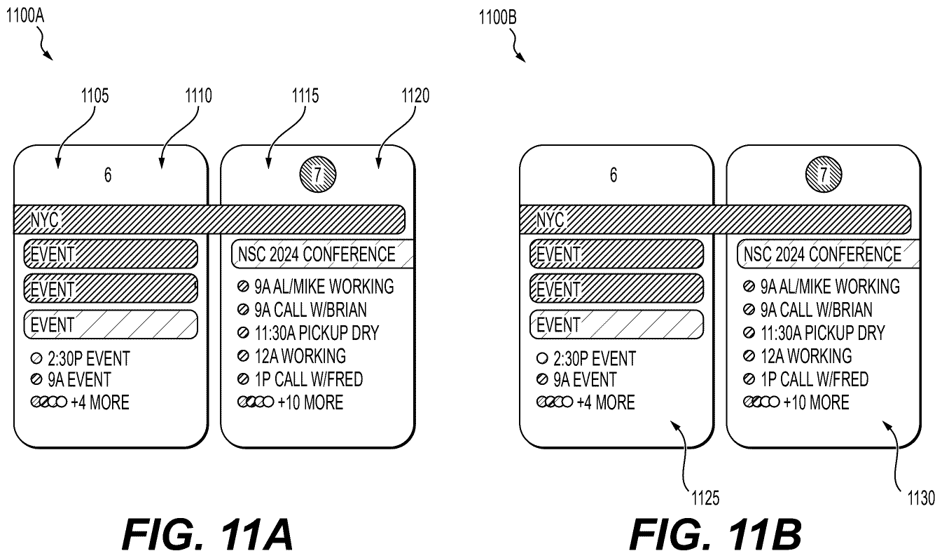

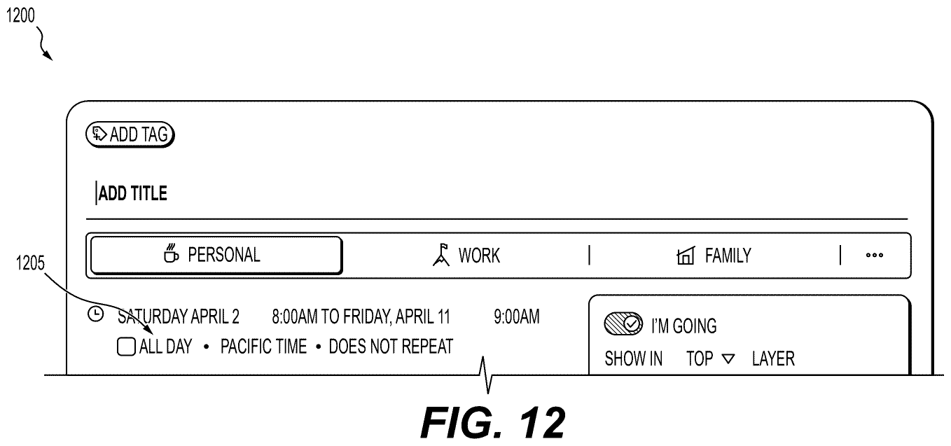

In an aspect, a user may create a new all-day event by selecting certain areas of any date, in either normal or expanded view. For example, a user may create an all-day event by selecting any blank space in the header area around a date, as illustrated by spaces 1105-1120 in diagram 1100A in FIG. 11A. As another example, a user may create an all-day event by selecting any blank space within the day that is not allocated to an event, as illustrated by spaces 1125, 1130 in diagram 1100B in FIG. 11B. In an aspect, a user may change an all-day event to a timed event by unselecting the “all-day checkbox” within an event creation popover, as illustrated by checkbox 1205 in popover 1200 in FIG. 12. In an aspect, if the foregoing box is unchecked, the system may dynamically select the closest hour to the current time as the start time of the event.

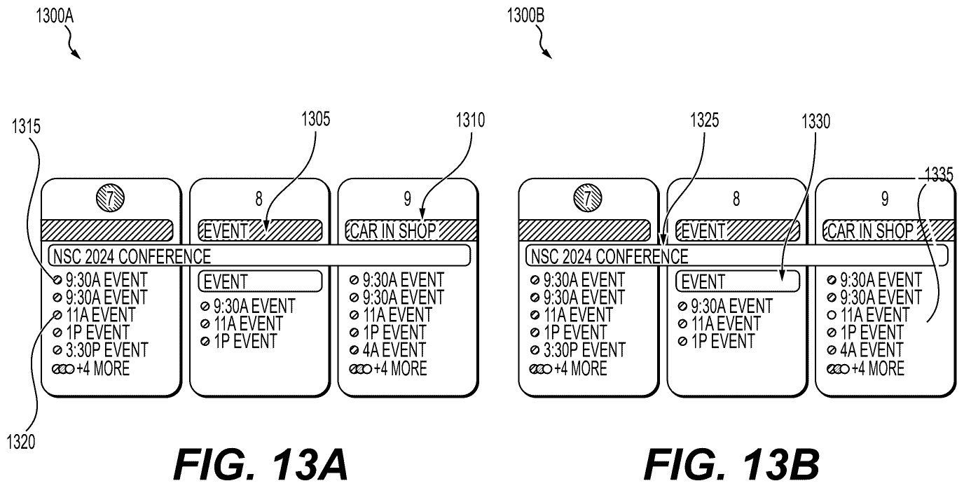

Within the electronic calendar, events may be styled according to the event type in order to make them more easily distinguishable and identifiable to users. In particular, commitment events may be styled different than awareness events. For instance, commitment events may be assigned specific colors to differentiate them from awareness events on the calendar. These colors are typically chosen by the user, or may follow a predefined color scheme. For example, commitment events may be represented by a distinct color, such as blue, to indicate their significance. For instance, diagram 1300A in FIG. 13A illustrates two instances, 1305 and 1310, of how an all-day commitment event may be presented. FIG. 13A also illustrates how timed commitment events may be presented, e.g., by a visually distinguished dot (e.g., blue dot) as represented in 1315 and 1320. Similar to commitment events, awareness events may also be styled in such a way as to differentiate them from other events on the calendar. For example, awareness events may be represented in gray or may be faded to de-emphasize their presence within the calendar application. For instance, diagram 1300B in FIG. 13B illustrates two instances, 1325 and 1330, of how all-day awareness events may be presented. FIG. 13B also illustrates how timed awareness events may be presented, e.g., by a faded or gray circle, as represented by event 1335.

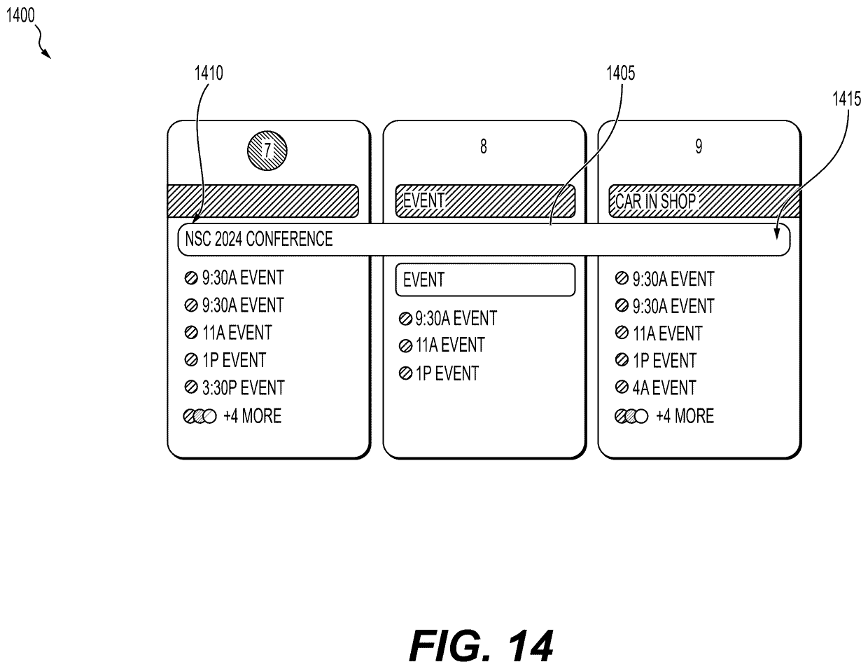

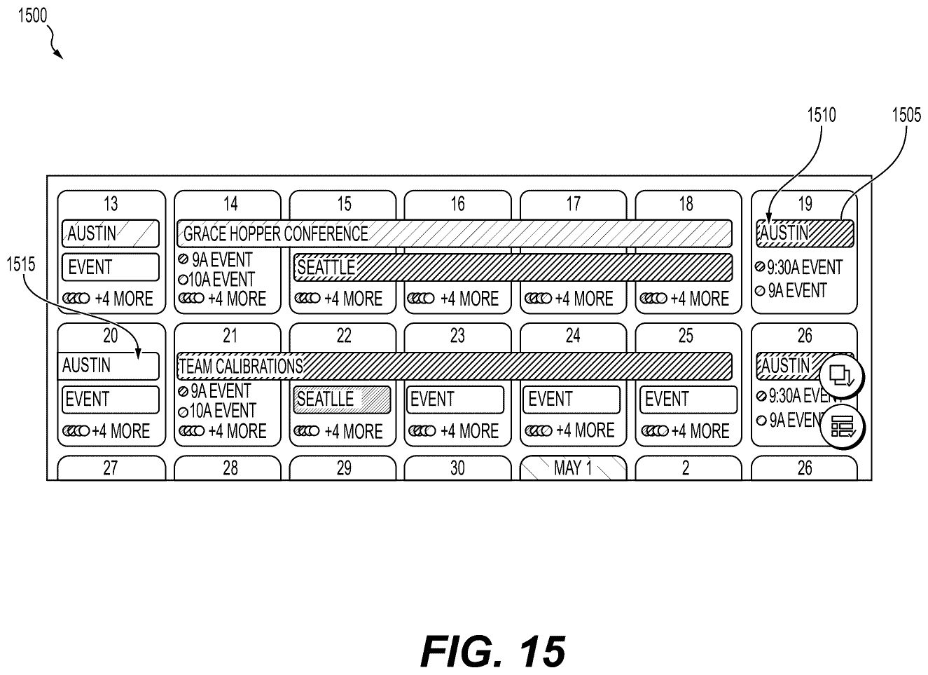

In an aspect, events that span two or more consecutive days may be considered multi-day events. These events may include vacations, conferences, project timelines, and other activities that extend beyond a single day. Multi-day events are visually represented on the calendar interface to indicate their duration. Typically, these events are displayed as blocks of time spanning across the day they occur. The block may start on the first day of the event and end on the last day, visually indicating the entire duration of the event. Similar to single-day events, multi-day events may have a background color that fills the space allocated for the event on each day of its duration. This background color helps to distinguish the event from other activities on the calendar and highlights its significance. FIG. 14 presents an example 1400 of a multi-day 1405 that spans three consecutive days in the same week. In example 1400, there may be white space, e.g., represented by spaces 1410 and 1415, before and after the multi-day event 1405 to provide a visual indication of when the event begins and concludes. FIG. 15 presents an example 1500 of a multi-day event 1505 that spans across two weeks. In example 1500, ends 1510, 1515 of the multi-day event 1505 may run all the way to the edge of the day with no white space in between.

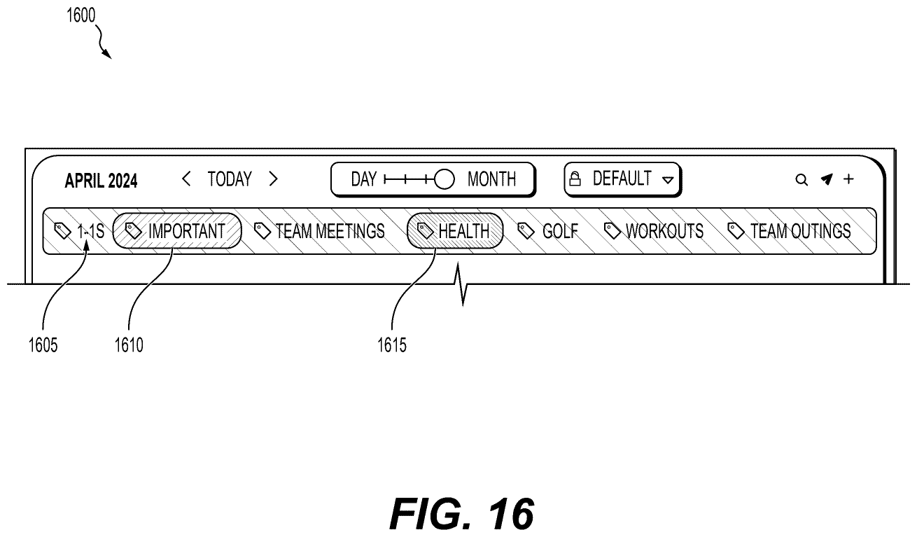

FIG. 16 provides an illustration of a navigation pane 1600 of a user's calendar that contains a tag bar 1605. Tag bar 1605 may be integrated with and co-displayed with the user's calendar and may contain a listing of all tags that the events in the user's calendar have been associated with. Further information regarding tags may be found in commonly owned U.S. patent application Ser. No. 18/671,255, which is incorporated by reference herein. For example, FIG. 16 illustrates a plurality of tags in tag bar 1605, including an “important” tag 1610 and a “health” tag 1615. Upon selection of any tag, the selected tag will display a color (e.g., once selected, important tag 1610 may be highlighted in a red color and health tag 1615 may be highlighted in an orange color). In an aspect, all events associated with the selected tag may then correspondingly adopt the color that the selected tag is highlighted in. For instance, using the previous example, each event associated with the important tag 1610 may be visually distinguished in red and each event associated with the health tag 1615 may be visually distinguished in orange.

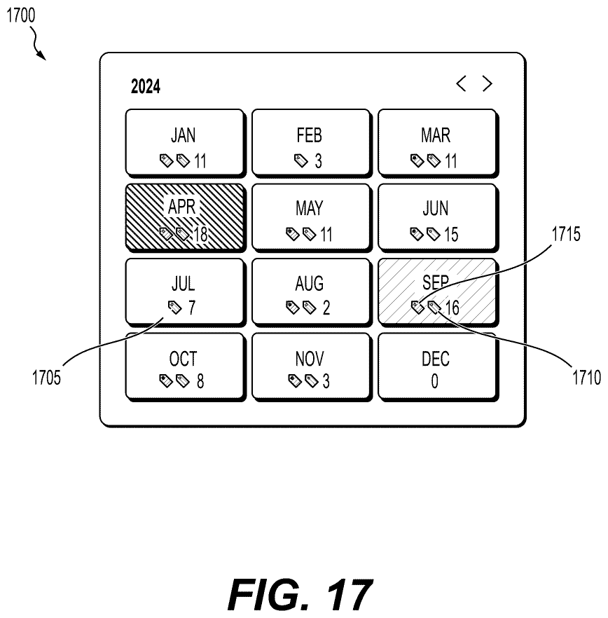

In an aspect, the tag colors may be reflected in the mini calendar as well. For instance, referring now to FIG. 17, an exemplary mini-calendar 1700 is displayed. Each month in mini-calendar 1700 that contains an event associated with a selected tag may provide an indication thereof via presentation of an icon that contains the color associated with the appropriate tag. For instance, the month July may contain a single colored tag icon 1705 that is presented in red. This may indicate that July contains at least one event associated with the “important” tag 1610. As another example, the month September may contain two colored tag icons, 1710, 1715, which may indicate that September contains an event associated with the “important” tag 1610 and an event associated with the health tag 1615. In an aspect, the tag icons may be displayed in the order of tag selection. For instance, the 1^{st} tag selected may have the corresponding tag icon color shown first. In an aspect, a numeral may be positioned next to the tag icons that may represent the total number of events that match any of the selected tags. For instance, the current month of April may contain 18 events that are associated with either the important tag 1610 or the health tag 1615. If there are no tag matches for the month, then the numeral “0” may be displayed, as indicated by the month December.

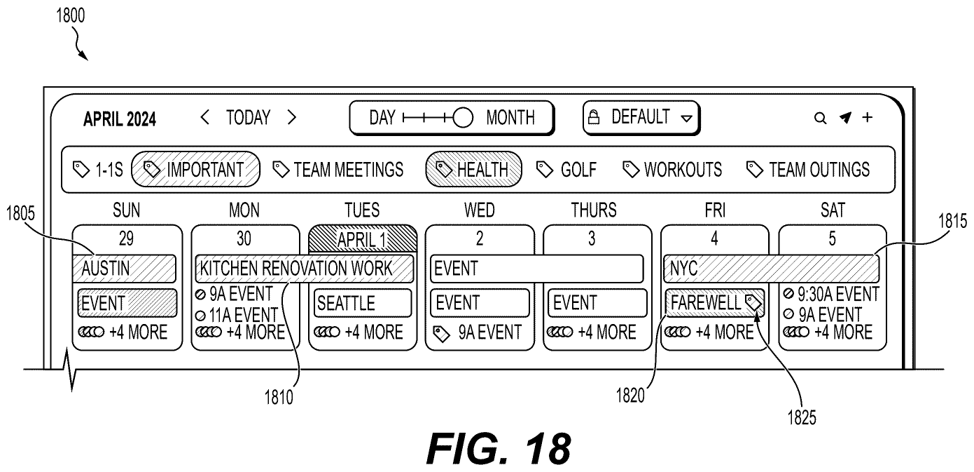

In an aspect, all day events may share the same background color of the selected tag. For instance, referring now to exemplary calendar 1800 in FIG. 18, the events “Austin” 1805, “Kitchen Renovation” 1810, and “NYC” 1815, match the red “important” tag 1610 whereas the event “Dylan Farewell HH” 1820 matches both the “important” tag 1610 and the “health” tag 1615. In an aspect, if multiple tags are selected, the background color may match the last tag selected, with previous tags shown as tag icons in another portion of the event (e.g., a bottom right hand corner of the event, etc.). For instance, a user may have selected the “important” tag 1610 before the “health” tag 1615. The event “Dylan Farewell HH” 1820 matches both tags, so the background color matches the last tag selected, which is orange for the “health” tag 1615 and has a pink tag icon 1825 in the right hand corner, which represents the “important” tag 1610.

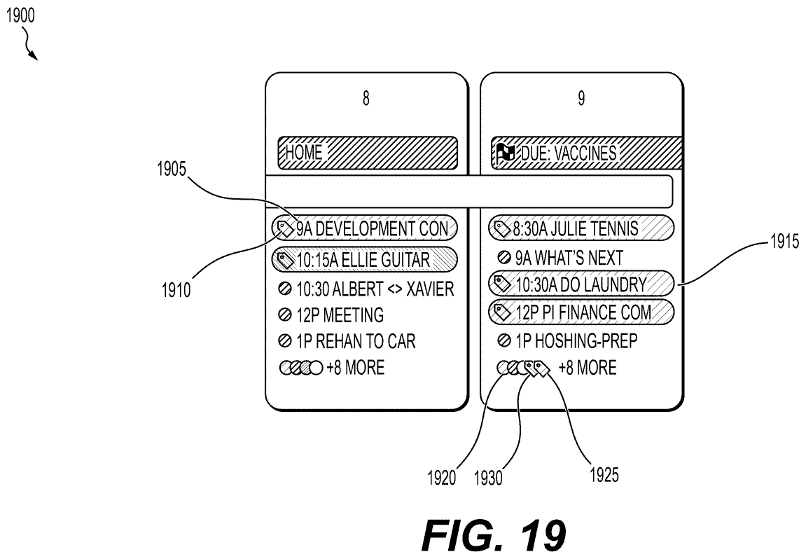

In an aspect, timed events with tags may be denoted with a colored tag icon and a highlighted text background color that matches the tag color. For instance, referring now to exemplary calendar portion 1900 in FIG. 19, a timed event 1905 at 9 am on the 8^{th} may contain a red tag icon 1910 and may be highlighted in red, which collectively indicates that event 1905 is associated with the “important” tag 1610. It is important to note that not just commitment events may contain these designations, but awareness events may contain them too. For instance, event 1915 occurring at 10:30 am on the 9^{th} may be an awareness event that still contains a red icon and faded red highlighting. In an aspect, if a timed event matches more than 1 tag, the color of the first matching tag may be utilized for the text background color as well as the icon color.

In an aspect, situations may arise where every timed event that is scheduled to occur on a specific day cannot be presented (e.g., due to space constraints, etc.). To provide the user with an indication of the number of tags that match the events contained in the overflow area, colored tag icons may be included in the overflow icons list. For instance, FIG. 19 presents an overflow list 1920 on the 9^{th} that contains a first and second colored icon, 1925 and 1930, which correspond to the “important” tag 1610 and the “health” tag 1615. The calendaring application may be configured to present a maximum of 5 colored icons or dots (e.g., representing commitment or awareness events) that are followed by a numerical indication of how many additional events are scheduled to occur on a given day that cannot be displayed. In an aspect, only one dot or tag icon will be displayed that matches each event type or tag, regardless of how many instances of events share that event type or tag. For instance, if there are 5 gray awareness events, only 1 grey dot will be displayed. Similarly, in another example, if there are 3 orange tabbed events, only 1 orange tag icon will be displayed. In an aspect, the calendaring application may be configured to present the last tag selected first in the overflow order, followed by the second to last tag selected, and so on. Thereafter, the colored dots for commitments events may be presented in chronological order, followed by colored dots for awareness events organized in chronological order.

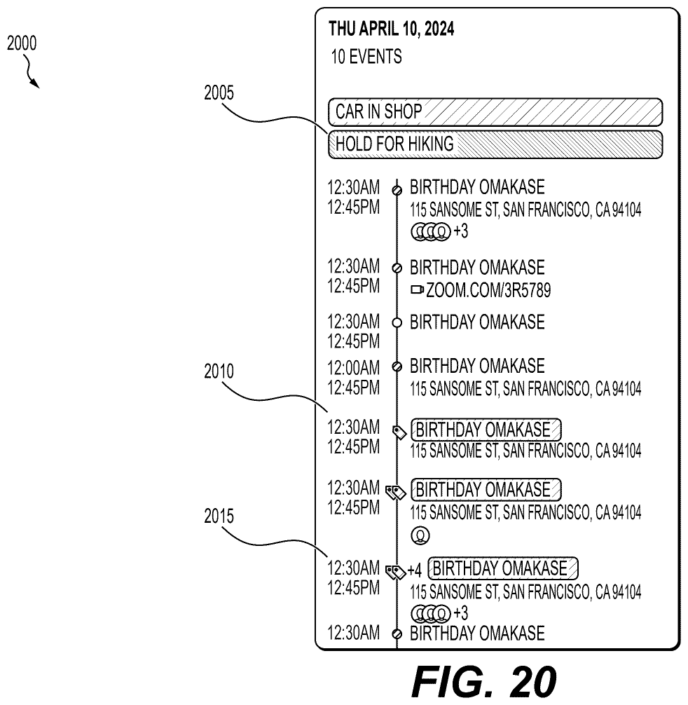

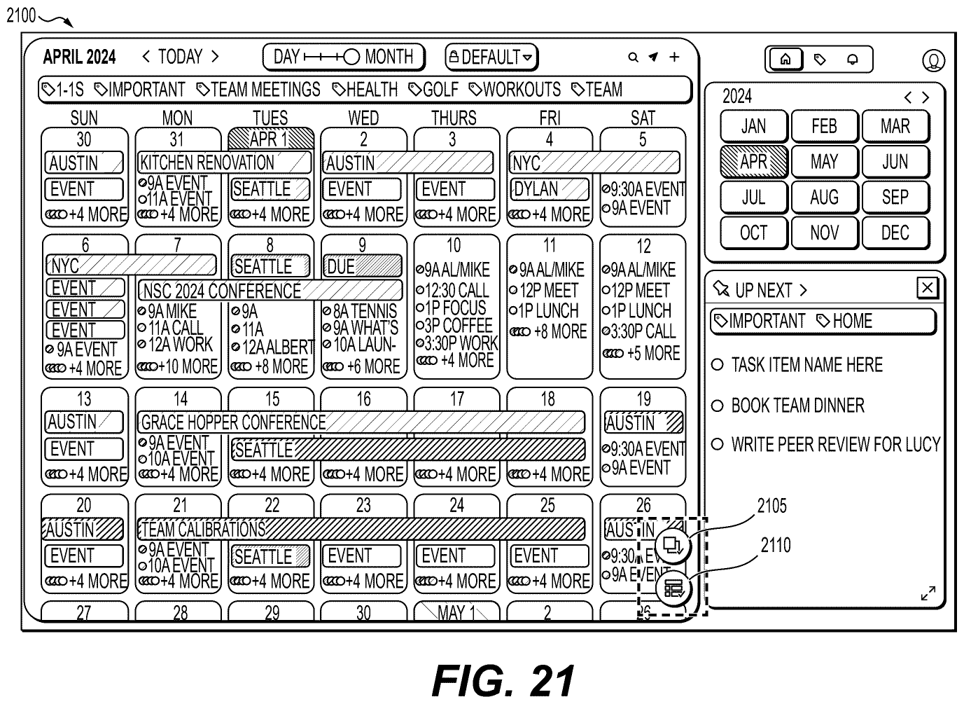

Referring now to FIG. 20, a popover 2000 providing a summary of daily events is presented according to an embodiment. In an aspect, a background color may be added for any all-day event that matches a selected tag that is present in popover 2000. For instance, all-day event 2005 may correspond to health tag 1615, so the background of all-day event 2005 may be orange, which is consistent for all events associated with health tag 1615. In an aspect, colored tag icons may be added next to any timed event that matches a selected tag. For instance, event 2010 may be associated with “important” tag 1610 and thus may corresponding include a red tag icon in its event line. The calendaring application may be configured to display up to 2 tag icons in each popover. If more tags are selected that match an event, they will be shown as +X, where “X” is the number of additional tag matches. For instance, event 2015 may be associated with 6 tags, but only two are explicitly shown.

Referring now to FIG. 21, an exemplary calendar 2100 is presented that includes event display toggles 2105 and 2110, whereby display toggle 2105 controls the presentation of awareness events and display toggle 2110 controls the presentation of timed events. More particularly, when display toggle 2105 is toggled off, a user may only see commitment events in their calendar and when toggled on, they may see both commitment and awareness events. Similarly, when display toggle 2110 is toggled off, users may only see all-day events in their calendar and when toggled on, they may see both all-day events and timed events. In an aspect, the default settings for these buttons may direct the calendaring application to show awareness events and show timed events.

In a first exemplary situation, when both toggles 2105, 2110 are on, all events will be shown. In a second exemplary situation, when both toggles 2105, 2110 are off, and no tags are selected, only the all-day commitments events will be displayed. In a third exemplary situation, when both toggles 2105, 2110 are off and tags are selected, then any all-day events that match the tags will be highlighted using the corresponding tag color. Additionally, the mini calendar may also update to show colored dots for matching events in each month, along with the number of total tagged events in each month. Furthermore, if a user chooses to expand a week on their calendar, and taps to open an event summary on one of the expanded days, they will see all events, both commitment and awareness events for all-day and timed events, even if the toggles are not selected on the main calendar. In a fourth exemplary situation, when toggle 2105 corresponding to awareness is on and toggle 2110 corresponding to timed events is off and no tags are selected, the user may see all-day awareness events, in addition to all-day commitment events. In a fifth exemplary situation, when toggle 2105 corresponding to awareness is on and toggle 2110 corresponding to timed events is off and tags are selected, both commitment and awareness events that are tagged may be highlighted.

### Weekend View

Conventional weekend views in electronic calendar systems often lack integration with the overall calendar layout, resulting in a disjointed user experience. More particularly, users may need to switch between different views to access weekend-specific information, which may be burdensome and inefficient. Additionally, traditional weekend view implementations do not prioritize events or tasks effectively. This lack of prioritization may make it challenging for users to distinguish between important commitments and less critical activities during weekends. Furthermore, many conventional weekend views offer static presentations of data, which fail to adapt to the dynamic scheduling needs of users. This rigidity limits user flexibility in organizing and managing weekend commitments efficiently. The inventive concepts described herein offer several benefits over conventional weekend views in electronic calendar systems, as further detailed herein.

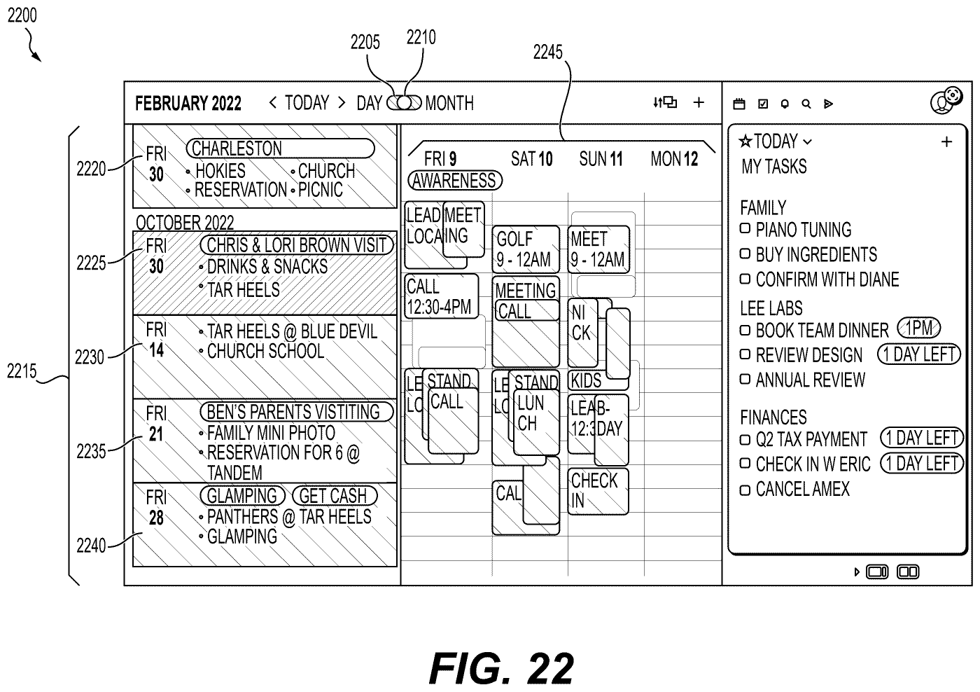

Referring now to FIG. 22, an exemplary calendar 2200 is presented in a weekend view mode. In an aspect, the weekend view mode may be entered into by moving toggle 2210 of slider 2205 to the designated position (e.g., a “weekend view” position situated between day and month view). In weekend view, the interface of calendar 2200 may be configured to display, e.g., on the left-hand side, a first section 2215 that contains a listing of the surrounding weekends (e.g., as designated by the Friday preceding each weekend) 2220-2240 and indication of the weekend events planned therein. Additionally, weekend view may also present a second section 2245 that provides a focused calendar view of each day in a particular weekend (e.g., a selected weekend). For instance, selection of one of the weekends 2220-2240 in the first section 2215 may cause the second section 2245 to update with the Friday-Monday event schedules that correspond to the selected weekend.

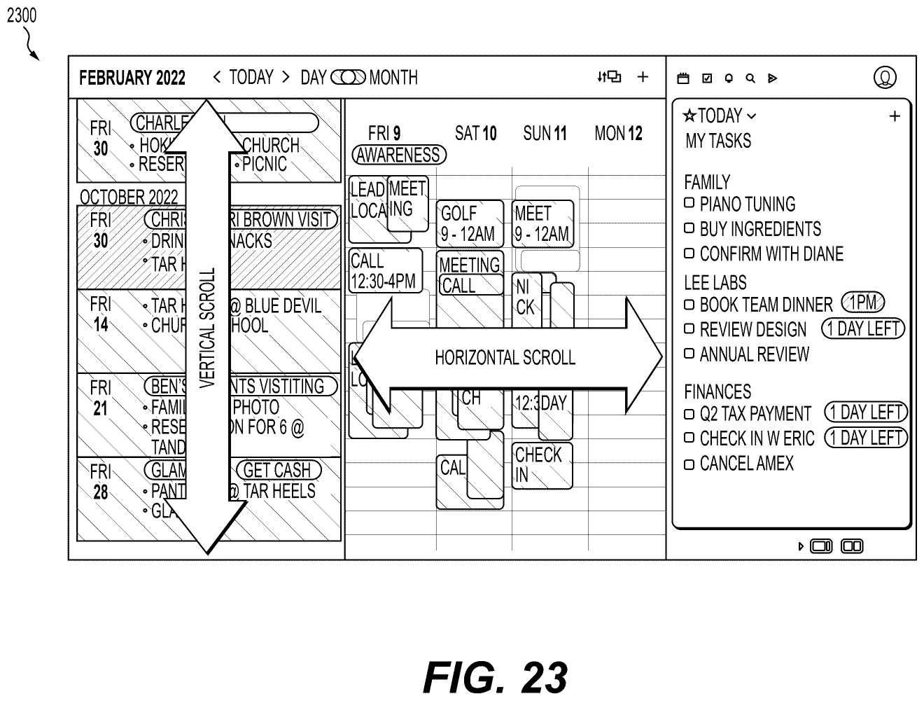

Referring now to FIG. 23, illustration 2300 presents that a user may be to perform horizontal and vertical scrolling within the weekend view. The inclusion of both horizontal and vertical scrolling in the weekend view offers several benefits to users. For instance, horizontal scrolling allows users to view a broader range of time periods within the weekend view, extending beyond the confines of a single day or week. Vertical scrolling provides users with the flexibility to navigate through different sections or layers of information within the weekend view. Users can easily move between days, weeks, or months, depending on their preferences and specific scheduling needs. This flexible navigation enhances user control and efficiency, allowing for quick access to relevant information without disrupting the overall view.

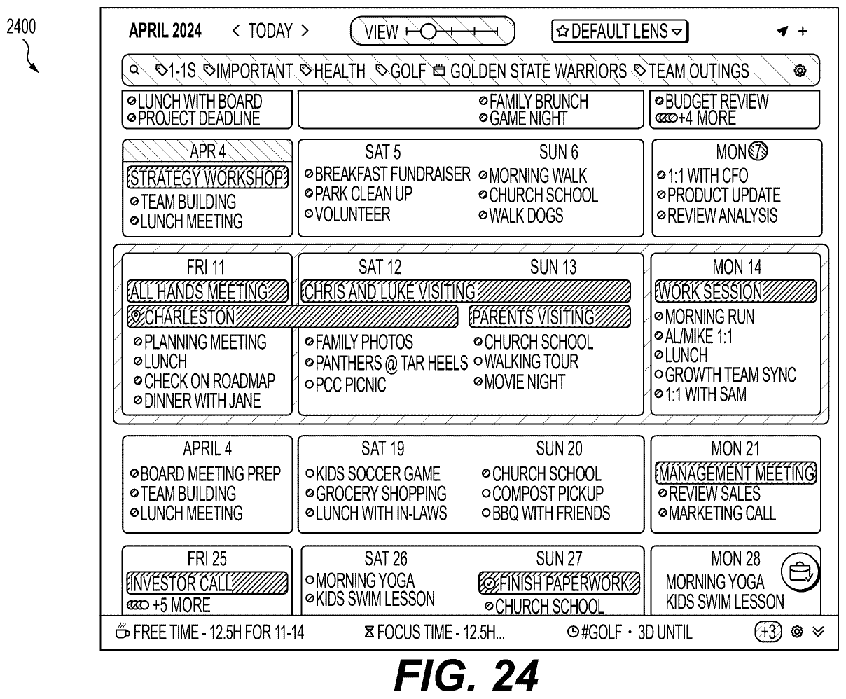

Referring now to FIG. 24, illustration 2400 presents a weekend view within an electronic calendar application, according to one or more aspects of the present disclosure. As shown, the weekend view may be configured to provide a specialized representation of calendaring data that emphasizes the days most relevant to the users' planning needs. In particular, the weekend view may highlight Saturday and Sunday together in a visually unified grouping. This grouping may advantageously allow users to conceptualize and plan their weekend activities holistically, rather than viewing each day in isolation. In addition to grouping Saturday and Sunday, the weekend view of FIG. 24 also provides visibility into the surrounding Friday and Monday. This design may be advantageous because many users experience transitional obligations on these days, such as travel, work deadlines, or preparatory tasks on Friday, and recovery, work resumption, or post-travel obligations on Monday. By incorporating Friday and Monday into the weekend display, the calendar application may provide the user with a contextualized, four-day window of activity that accurately reflects how many individuals plan and experience their weekends. For instance, a user preparing for travel may readily identify whether a Friday afternoon commitment conflicts with a planned departure time, or whether Monday morning obligations may be impacted by late Sunday activities.

As further shown in FIG. 24, the weekend view may employ differentiated containers to display events for each day within the Friday-Monday block. Each container may list all-day events and timed events, and may further indicate overflow events where space is limited. Additionally, the interface may incorporate tag-based filtering, color-coding, and prioritization mechanisms, enabling users to quickly distinguish between awareness events and commitment events across the weekend block. In some aspects, vertical scrolling may allow navigation through multiple upcoming weekends, while horizontal scrolling may facilitate a detailed view of individual days within a selected weekend.

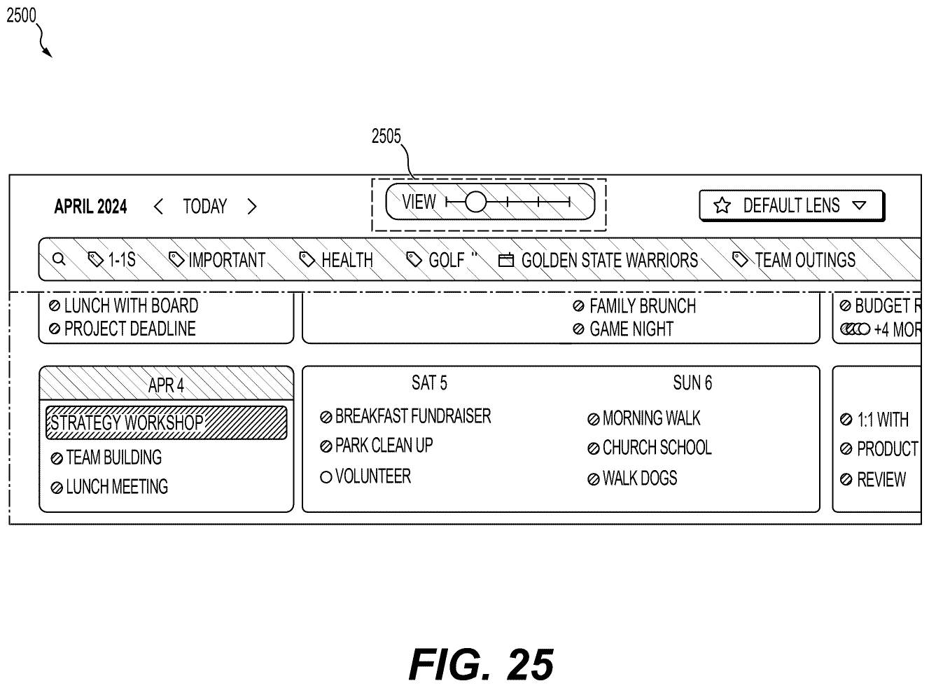

Referring now to FIG. 25, illustration 2500 presents a view slider 2505 within the top navigation area of an electronic calendar application, according to one or more aspects of the present disclosure. As shown, the view slider 2505 provides users with an intuitive control mechanism to transition between different calendar display modes, including day view, month view, and, in certain embodiments, the weekend view described herein. In an aspect, the view slider 2505 may be manipulated by a user through a drag-and-drop interaction or by selecting discrete slider positions, each position corresponding to a different calendar view type. In an aspect, a transition to the weekend view mode may be incorporated into the view slider 2505, as further described herein. In an aspect, the view slider 2505 may be persistently co-displayed within the top navigation bar, ensuring that users can access and switch to the weekend view at any time without disrupting their workflow. Additionally, the view slider 2505 may be configured to provide visual or animated feedback when transitioning between views, further enhancing the user experience by reinforcing the contextual shift in displayed event data.

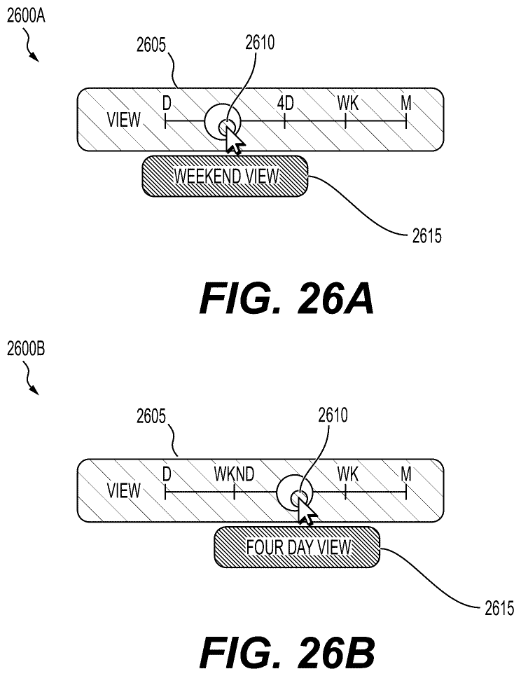

Referring now to FIGS. 26A and 26B, exemplary illustrations 2600A and 2600B are presented that depict interactive use of the view slider 2605 within the top navigation area of an electronic calendar application, according to one or more aspects of the present disclosure. As shown in FIG. 26A, the view slider 2605 may include a movable toggle element 2610 that may allow a user to seamlessly transition between different calendar views, such as day view, weekend view, four-day view, week view, and month view. When a user positions the movable toggle element 2610 over a given marker, a corresponding hover-state indicator 2615 (e.g., a tooltip) may appear to provide contextual feedback, such as the text “Weekend view.” This feedback ensures that users are aware of which calendar view will be activated prior to finalizing their selection. FIG. 26B illustrates a subsequent state in which the movable toggle element 2610 has been moved further along the view slider 2605, with the hover-state indicator 2615 now displaying “4 day view.” In this aspect, the movable toggle element 2610 may be manipulated by dragging along the slider track or by selecting a discrete position directly, thereby transitioning the calendar interface from one display mode to another. Each position on the view slider 2605 may correspond to a distinct calendaring perspective, ranging from narrow, granular views (e.g., day view) to broader temporal views (e.g., month view).

In an aspect, the inclusion of the weekend view (Wknd) as a selectable option within the view slider 2605 distinguishes the disclosed system from conventional calendar interfaces. More particularly, this view, when selected, may present a contextually rich representation of Friday through Monday, enabling users to visualize weekend commitments together with transitional obligations at the start and end of the weekend. By integrating the weekend view directly into the view slider 2605 navigation, the system elevates the weekend view to the same level of accessibility as traditional calendar modes, ensuring users are able to rapidly shift into this planning perspective without requiring additional navigation steps.

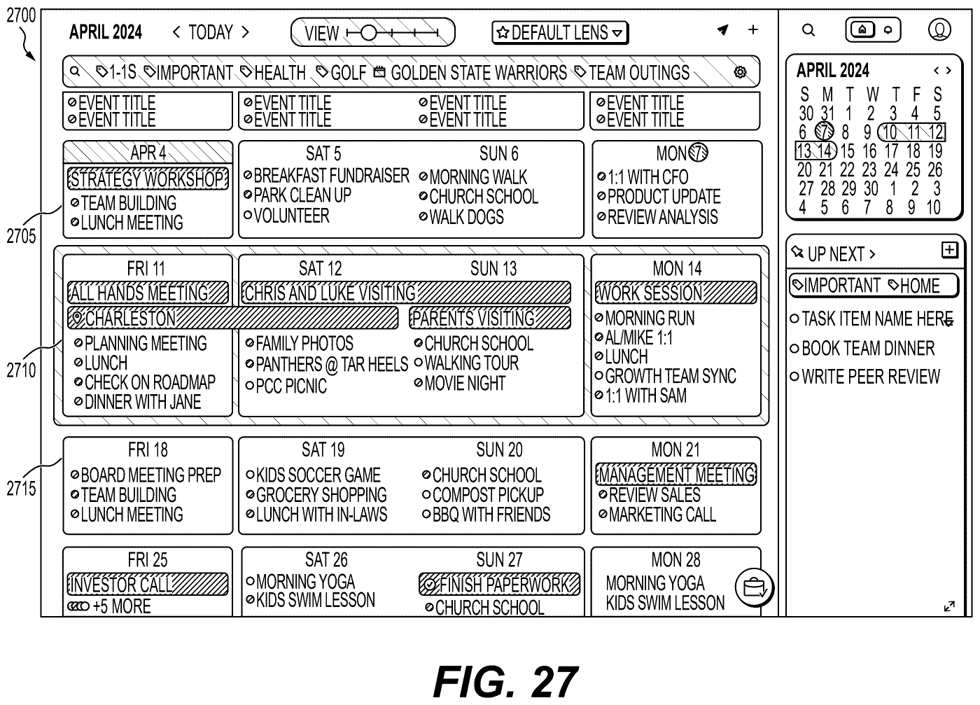

Referring now to FIG. 27, an exemplary illustration 2700 of a weekend view within an electronic calendar application is presented, according to one or more aspects of the present disclosure. As shown, the interface may provide a contextualized display of multiple weekends across a given month, with certain weekends being designated as selected weekends (e.g., weekend 2710) while others remain in a compact, unselected state (weekends (2705 and 2715). This configuration may be designed to balance the need for high-level visibility of numerous weekends with the need for detailed information about a particular weekend of user interest. More particularly, similar to the functionality described for the month earlier described herein, weekends that are not selected may be displayed in a compact format, thereby conserving visual space and minimizing on-screen clutter. In this compact state, only limited event information may be shown, e.g., such as event titles or high-priority indicators, while more granular details (e.g., participants, locations, or time blocks) may be hidden from view. By contrast, when a weekend is designated as a selected weekend, the system may dynamically expand the display for that weekend, presenting a richer and more comprehensive set of event information. For example, weekend 2710 corresponds to a selected weekend view that provides additional event rows, detailed scheduling entries, and clearer contextual indicators for both all-day and timed events.

In some aspects, the selection of a weekend may occur automatically (e.g., defaulting to the weekend closest to the current date) or through explicit user interaction (e.g., by clicking or tapping on a desired weekend). In some aspects, transitions between compact and expanded states may be accompanied by visual animations to reinforce the user's focus and maintain continuity within the interface. Additionally, compacted weekends may still provide contextual cues such as tag icons, color highlights, or event counts, enabling users to quickly identify weekends that may warrant expansion for more detailed review.

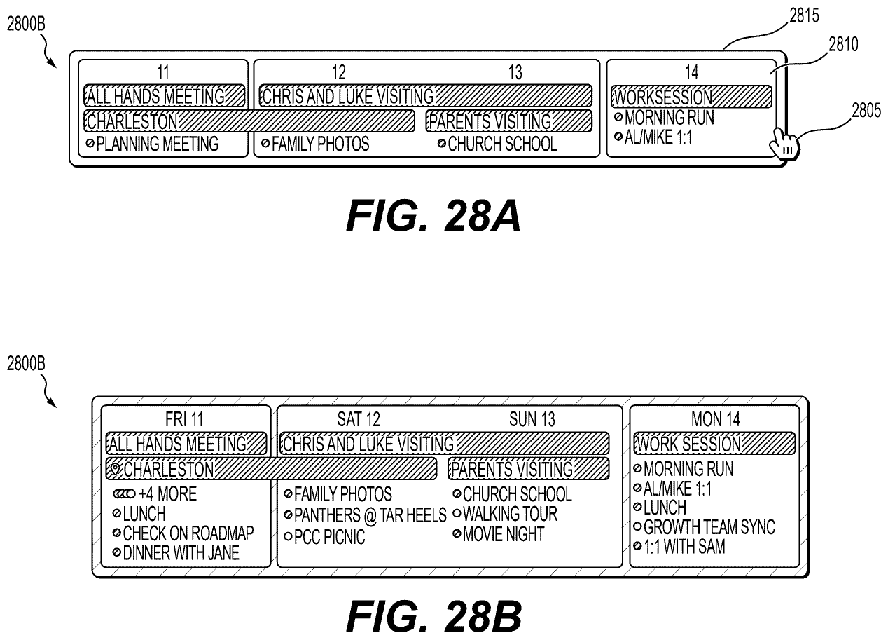

Referring now to FIGS. 28A and 28B, exemplary illustrations 2800A and 2800B are presented that demonstrate the interactive functionality of hovering over unselected weekends within the weekend view of an electronic calendar application, according to one or more aspects of the present disclosure. As shown in FIG. 28A, when a user positions a cursor 2805 over an unselected weekend 2810, the system may dynamically generate a border 2815 or other visual indicator around the corresponding weekend container. This visual feedback may inform the user that the hovered weekend may be selected for expansion and may provide a clear cue as to the system's interactive state.

In an aspect, if the user subsequently clicks on the border 2815 or within the bounded region while hovering, the hovered unselected weekend transitions into a selected weekend state, as depicted in FIG. 28B. In this expanded state, the system reorganizes and presents a greater volume of event information for the selected weekend, including additional rows of events, detailed descriptions, and contextual metadata such as participants and locations. This dynamic transition from compact to expanded display allows users to fluidly navigate between multiple weekends while maintaining focus on the most relevant timeframes for planning.

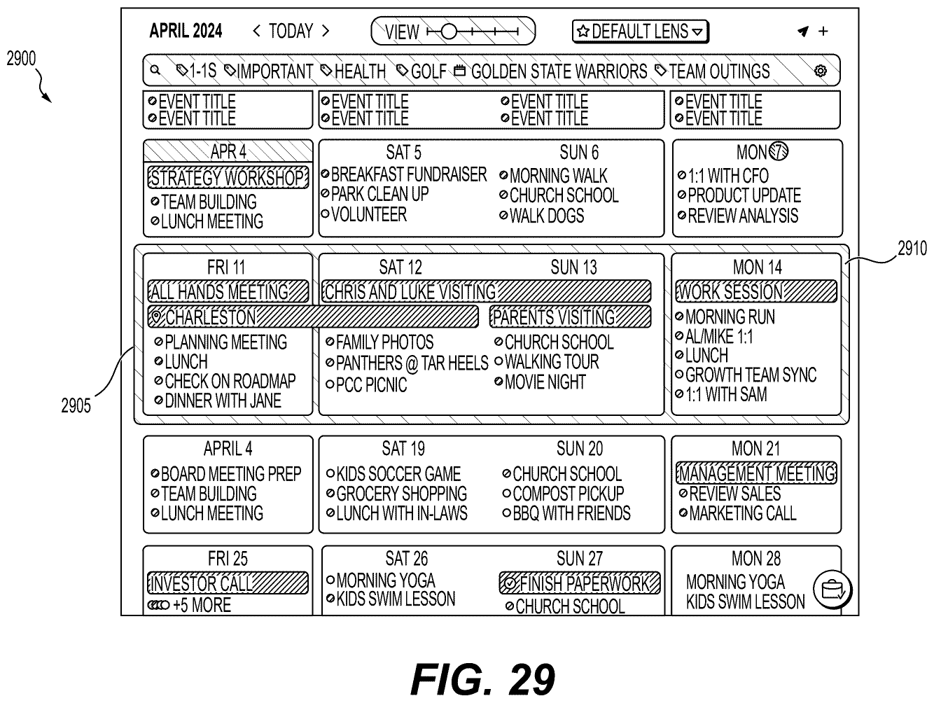

Referring now to FIG. 29, an exemplary illustration 2900 is provided that demonstrates how a selected weekend may be visually distinguished within the weekend view of an electronic calendar application, according to one or more aspects of the present disclosure. As shown, weekend 2905 is displayed with a visually distinguished border 2910 (e.g., a blue border) that surrounds the container. This border 2910 may function as a clear visual cue to the user that this weekend has been designated as the currently selected weekend, thereby distinguishing it from the surrounding, unselected weekends. In addition to the border 2910, the selected weekend 2905 may also be rendered with a greater vertical height than unselected weekends. This additional space may allow for the presentation of more event information, including detailed titles, time-specific commitments, and multiple all-day events, without truncation. By contrast, unselected weekends may remain in a more compact state, displaying only limited event information so as to conserve visual space and minimize on-screen clutter. This arrangement balances the need to present a comprehensive view of one weekend while still maintaining visibility of neighboring weekends. In some aspects, the default selected weekend may automatically correspond to the upcoming weekend that is closest to the current day. For instance, if the current date is Thursday, April 10, the system may default to highlighting the April 11-14 weekend (e.g., weekend 2905) as the selected weekend. This default behavior may ensure that the interface proactively presents the most immediately relevant timeframe to the user, thereby reducing the number of interactions required to access pertinent scheduling information.

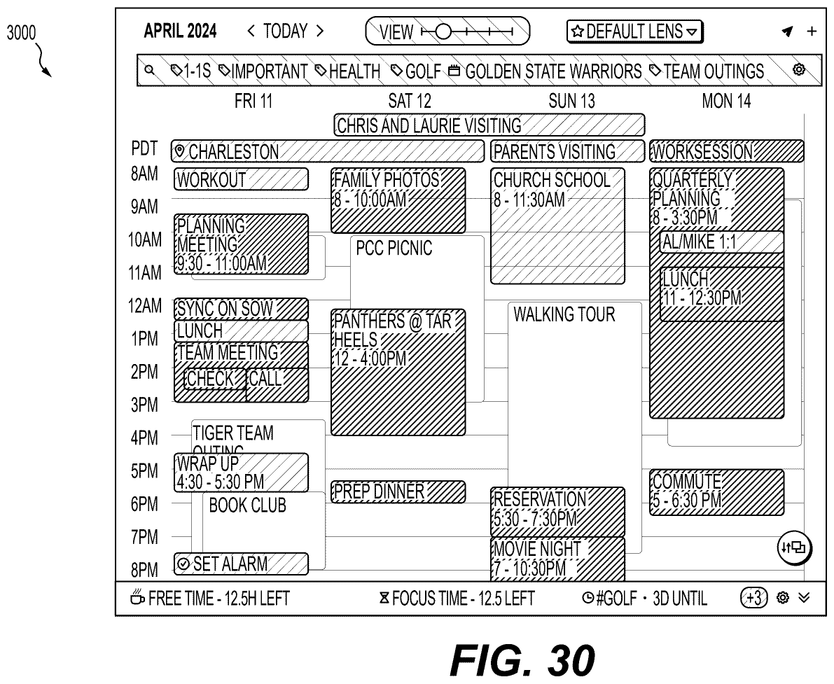

Referring now to FIG. 30, an exemplary illustration 3000 is presented that depicts the functionality of transitioning from a selected weekend view into a four-day detailed view, according to one or more aspects of the present disclosure. As described previously with respect to FIG. 29, a selected weekend may be visually distinguished by a border (e.g., border 2910 in FIG. 29) surrounding the weekend container. In the aspect shown in FIG. 30, clicking on this border may trigger a navigation event that causes the system to expand the selected weekend into a 4-day view encompassing Friday, Saturday, Sunday, and Monday. As illustrated, the 4-day view may provide a more granular and time-structured representation of events across the four days. In this view, events may be aligned according to their scheduled times, and each day is divided into hourly increments, allowing users to clearly visualize overlaps, gaps, and precise scheduling conflicts. For instance, Friday events such as “Planning meeting” and “Sync on SOW” are shown in dedicated time slots, while Saturday's activities include a “Family mini photo session” and a sporting event, each rendered proportionally based on duration. Similarly, Sunday and Monday are expanded to display both all-day and time-specific commitments.

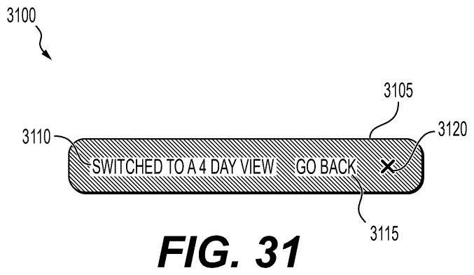

Referring now to FIG. 31, an exemplary illustration 3100 is presented that depicts a toast notification 3105 displayed to a user upon transitioning from a weekend view into a four-day view, according to one or more aspects of the present disclosure. As shown, the toast notification 3105 may include a textual message 3110 (e.g., “Switched to 4 Day View”) that may provide immediate contextual feedback confirming that the requested navigation action has been successfully executed. In addition to confirming the view change, the toast notification 3105 may further include an interactive control 3115 labeled “Go back” By selecting this interactive control 3115, the user may seamlessly return to the prior weekend view without the need to manually reposition the view slider or reselect the weekend container. This feature improves usability by allowing users to quickly reverse their navigation if the four-day view does not meet their immediate planning needs. In some aspects, the toast notification 3105 may also include a dismiss control 3120 (e.g., an “X” button) that may allow the user to remove the toast notification 3105 from the interface without affecting the underlying view.

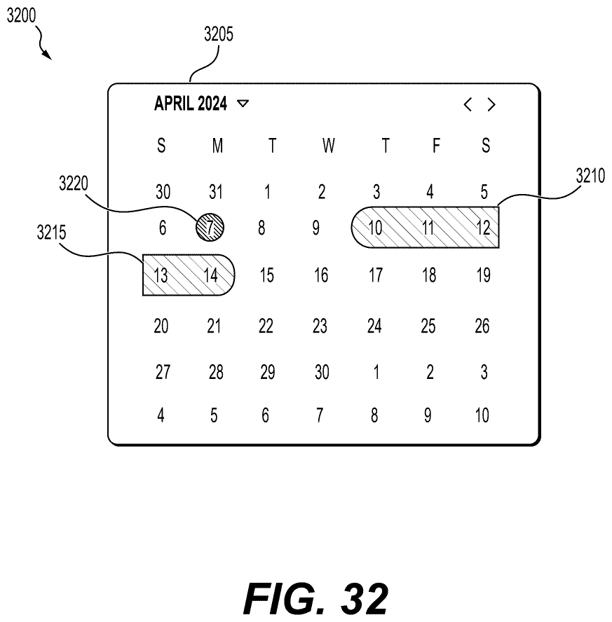

Referring now to FIG. 32, an exemplary illustration 3200 is presented of a mini-calendar 3205 associated with the weekend view of an electronic calendar application, according to one or more aspects of the present disclosure. As shown, the mini-calendar 3205 may provide a compact, month-level visualization that may allow users to quickly identify and navigate to specific weekends of interest. Within this view, the selected weekend 3210 may be visually highlighted using a distinct graphical treatment to differentiate it from unselected weekends and other calendar days. For instance, in an aspect, the selected weekend 3210 may be emphasized by use of a shaded border 3215 that encapsulates the four relevant days. This border 3215 may provide a continuous visual grouping across consecutive days, thereby reinforcing the system's contextual emphasis on weekends as multi-day planning units that include both transitional and core weekend days. The shading may be applied with a gradient or color distinction to further distinguish the selected weekend 3210 from the remainder of the month. Additionally, in an aspect, the current day (e.g., April 7) may be highlighted with an indicator 3220 (e.g., circular indicator), enabling users to quickly orient themselves temporally within the broader calendar. By combining a current-day indicator with a shaded weekend highlight, the mini-calendar 3205 may effectively communicate both where the user is today and which weekend is currently active in the main weekend view.

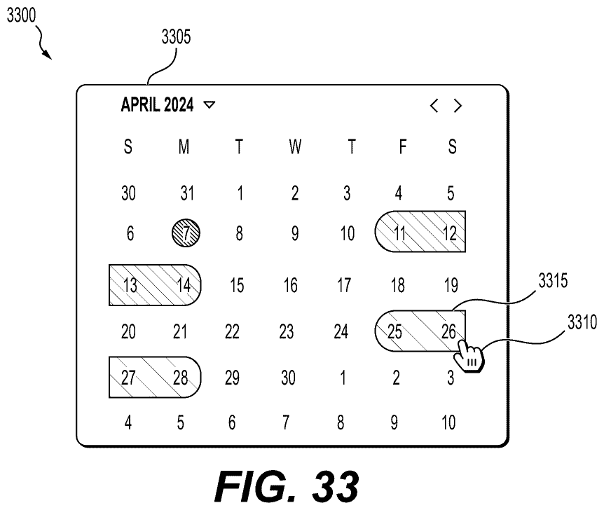

Referring now to FIG. 33, an exemplary illustration 3300 is presented that demonstrates the interactive functionality of selecting a weekend from the mini-calendar 3305 in connection with the weekend view of the electronic calendar application, according to one or more aspects of the present disclosure. As shown, a user may position a cursor 3310 over weekend 3315. In an aspect, if the user clicks on weekend 3315 in the mini-calendar 3305, the system may automatically scroll the main calendar canvas to bring the corresponding weekend into view. Once in view, the selected weekend 3315 may be dynamically expanded into its detailed state, as described previously in connection with selected weekend. For instance, this expanded state may include a taller container with additional event rows, detailed scheduling information, and contextual metadata, while unselected weekends may remain in their compact form.

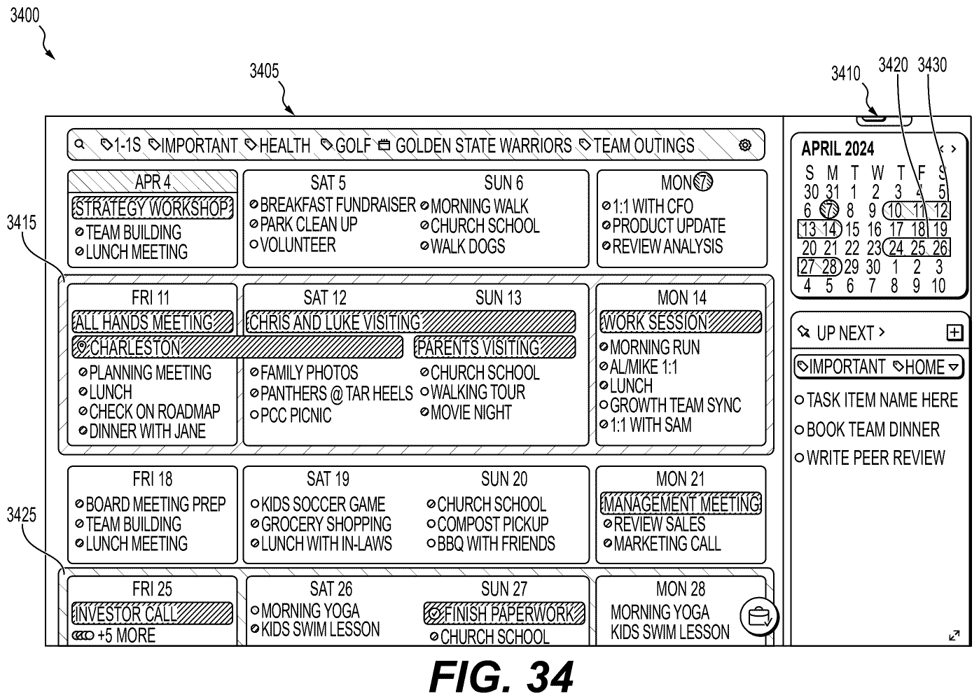

Referring now to FIG. 34, an exemplary illustration 3400 is presented that demonstrates the synchronization between the main calendar canvas 3405 and the mini-calendar 3410 in an electronic calendar application, according to one or more aspects of the present disclosure. As shown, the main calendar canvas 3405 displays multiple weekends in either compact or expanded form, while the mini-calendar 3410 provides a smaller month-level view positioned adjacent to the main calendar canvas 3405. In an aspect, scrolling within the main calendar canvas 3405 may reveal different weekends, or hovering over a particular weekend within the main calendar canvas 3405 may cause the corresponding weekend to be visually highlighted in the mini-calendar 3410. This may be accomplished by applying the same hover state treatment in the mini-calendar 3410 that is used when a user directly interacts with it. For example, if the user scrolls the main canvas 3405 so that weekend 3415 is brought into focus, that same weekend 3420 may be outlined or shaded in the mini-calendar 3410 to indicate its correspondence with the portion of the canvas currently being viewed. Similarly, if the user hovers their cursor over the weekend 3425 in the main canvas 3405, the mini-calendar 3410 may dynamically highlight the corresponding weekend 3430, providing a synchronized cue across both interface components.

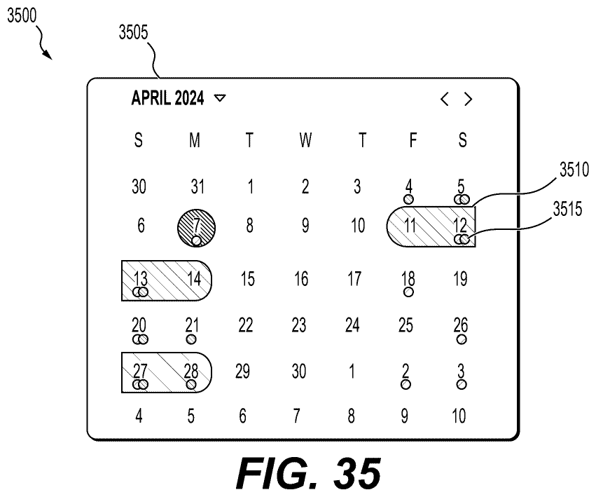

Referring now to FIG. 35, an exemplary illustration 3500 is presented that depicts how tags may be displayed in the mini-calendar 3505 when operating in weekend view, according to one or more aspects of the present disclosure. As shown, the mini-calendar 3505 may present a month-level overview of April 2024, with specific weekends highlighted (e.g., weekend 3510) using a shaded border treatment as described previously. In addition to these highlights, the mini-calendar 3505 may be configured to display dots 3515 (e.g., colored dots) beneath certain dates, indicating the presence of events that have been assigned tags. In an aspect, the dots 3515 may serve as visual indicators of tagged events associated with weekends, enabling users to quickly assess the distribution of particular event categories across multiple weekends. For example, as illustrated in FIG. 35, both April 11-12 and April 13-14 include multiple dots of different types (e.g., different colors), each corresponding to one or more tags such as “work,” “family,” “health,” or other user-defined categories. This functionality may provide a compact yet meaningful representation of event metadata directly within the mini-calendar 3505, thereby bridging high-level navigation with contextual awareness of event categorization. In an aspect, in the weekend view mode, the system may be configured to display dots only on dates that fall within Friday, Saturday, Sunday, or Monday. This constraint may ensure that tagging indicators remain aligned with the weekend-centric focus of the interface and prevents extraneous information from cluttering the mini-calendar display.

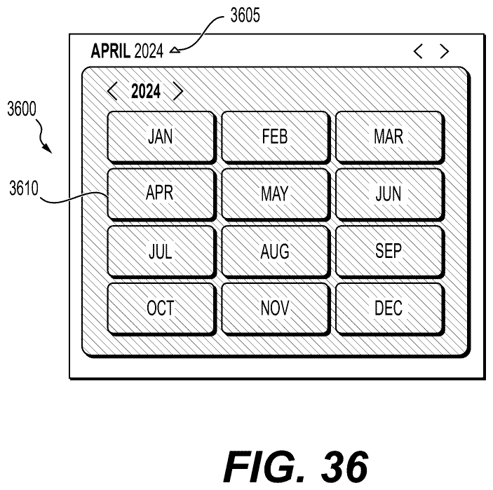

Referring now to FIG. 36, an exemplary illustration 3600 is presented that demonstrates the functionality of a month picker drop-down 3605 in association with the mini-calendar of the weekend view, according to one or more aspects of the present disclosure. As shown, when a user clicks on the month and year drop-down control 3605 located at the top of the mini-calendar (e.g., “April 2024”), the interface may generate and display a drop-down picker containing all twelve months of the currently selected year. In an aspect, the drop-down picker may be arranged in a grid format, with each month represented by an interactive title (e.g., “January,” “February,” “March,” . . . “December”). The currently active month 3610 April, may be visually distinguished with a highlight treatment, allowing the user to immediately recognize the month that is currently in view within the mini-calendar. Other months remain selectable, and clicking on any month tile causes the mini-calendar to update its display to the selected month while preserving synchronization with the main canvas. For example, if the user selects “July,” the mini-calendar will shift to show the weekends of July 2024, and the main canvas may automatically scroll to the corresponding timeframe if desired).

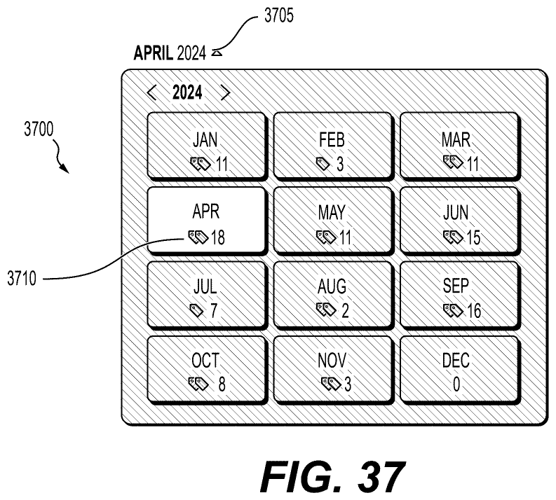

Referring now to FIG. 37, an exemplary illustration 3700 is presented that demonstrates how tags may be incorporated into the month picker drop-down 3705 to assist users in quickly locating months with relevant tagged events, according to one or more aspects of the present disclosure. As shown, when the user opens the month picker drop-down 3705 by clicking on the month and year field in the mini-calendar, each month of the year is displayed in a selectable tile. In addition to the month label, the system may display tag indicators 3710 that reflect both the color of the tags and the total number of events associated with those tags for weekends within that month. For example, April may be highlighted with two colored tag icons and the number “12,” signifying that there are twelve events in April matching the user's selected tags. Similarly, other months such as March and September display tag counts of “18” and “16” respectively, along with their associated tag color markers. By contrast, December displays “0,” indicating that no events in that month match the selected tags. The use of colored tag markers provides users with immediate context about the types of events present (e.g., work-related, family, health), while the numerical count gives an at-a-glance summary of the event density.

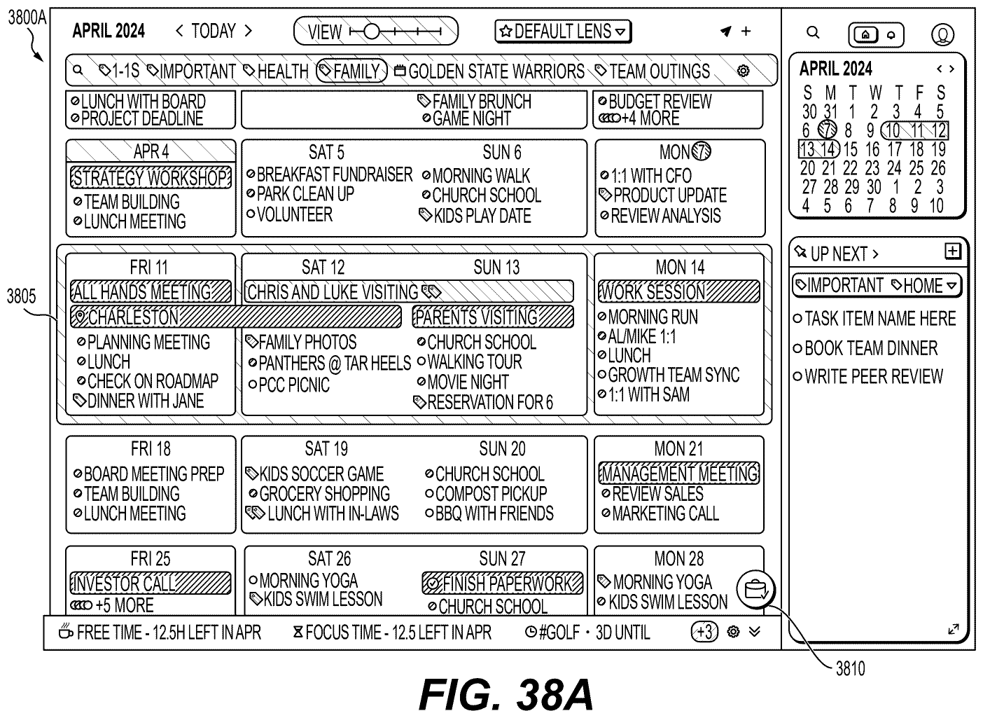

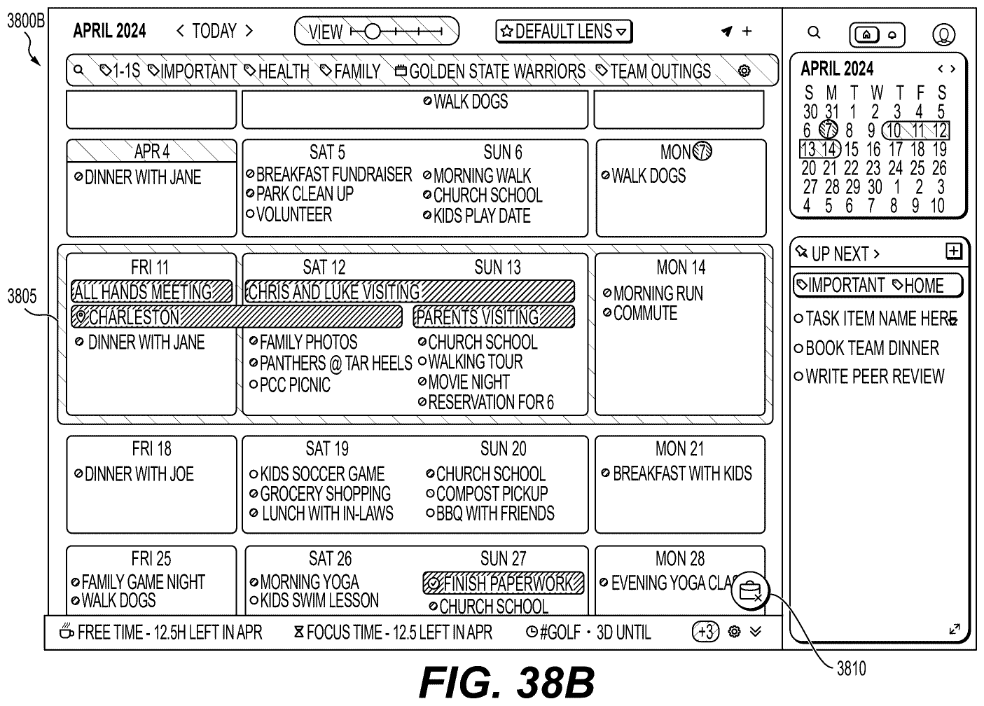

Referring now to FIGS. 38A and 38B, exemplary illustrations 3800A and 3800B are presented that demonstrate the ability for users to selectively show or hide work events within the weekend view of the electronic calendar application, according to one or more aspects of the present disclosure. As illustrated in FIG. 38A, when the work calendar is shown (default state), the weekend view may present both personal and professional events together within the selected weekend container. For instance, in addition to family activities and social commitments, work-related obligations such as “Management roundtable” and “Customer feedback review” may be displayed within the expanded weekend view 3805. This default presentation may ensure that users are provided with a comprehensive view of all commitments, enabling them to consider potential conflicts between personal and work obligations. By contrast, FIG. 38B illustrates the weekend view after the user has elected to hide the work calendar (e.g., by toggling element 3810). In this state, work-related events may be filtered out, and the weekend view displays only personal, family, or other non-work commitments. This streamlined presentation helps reduce visual clutter and allows users to focus exclusively on personal planning during weekends, aligning with the common practice of reserving weekends for non-professional activities.

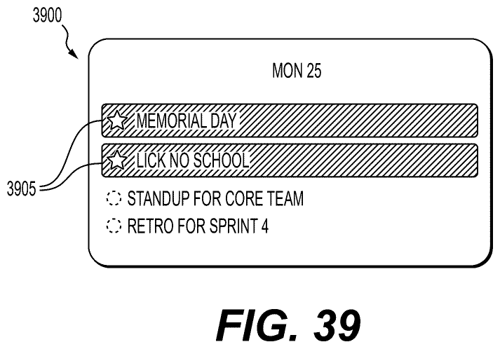

Referring now to FIG. 39, an exemplary illustration 3900 is presented that demonstrates the holiday event treatment within the weekend view of an electronic calendar application, according to one or more aspects of the present disclosure. As shown, events that are designated or tagged as “holiday” may be visually distinguished from other events by the presence of an icon 3905 (e.g., a star icon), e.g., displayed to the left of the event title. For instance, in FIG. 39, the events “Memorial day” and “Lick no school” have been tagged as holidays and are accordingly rendered with a star icon and a distinct background treatment. This design ensures that holiday events may be immediately recognizable within the broader context of a user's calendar, even when displayed alongside standard work or personal events such as “Standup for Core team” or “Retro for Sprint 4.” In an aspect, the holiday treatment may be applied automatically based on system-provided holiday calendars, or it may be user-defined, allowing users to mark specific cultural, religious, or personal observances as holidays. The icon 3905 may also be color-coded or stylized (e.g., filled or outlined) to distinguish between global holidays, local holidays, and personal holiday designations.

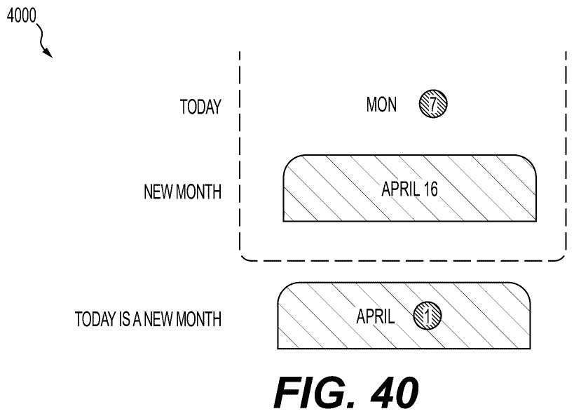

Referring now to FIG. 40, an exemplary illustration 4000 is presented that depicts how the system may visually treat “Today” and “New Month” indicators within the weekend view of an electronic calendar application, according to one or more embodiments of the present disclosure. Because the weekend view primarily displays Friday through Monday, the start of a new month may not always align with the first day of the month (i.e., the 1^{st}), and therefore special treatments may be provided to ensure clarity. As shown, when the current day (Today) falls within the weekend view, it may be visually highlighted with a distinct label or marker. For example, “Mon 7” is presented with a bold circular indicator, drawing user attention to the present date within the displayed weekend. In an aspect, when the system encounters the start of a new month within the weekend view, a special New Month indicator may be displayed. For instance, “April 16” may be labeled as a new month transition point, even though it does not fall on the 1^{st} of the month. This ensures that users remain aware of month boundaries when reviewing extended weekend sequences. Additionally, in an aspect, when “Today” coincides with the start of a new month, the system may combine both treatments into a unified display. As shown in illustration 4000, “April 1” is rendered with both a circular highlight (indicating Today) and a shaded background (indicating New Month). This dual-treatment clearly communicates to the user that the present day is both the current day and the first weekend representation of a new month.

In an aspect, the calendaring application may leverage A.I., e.g., embodied as a trained machine learning model, to help a user identify a weekend, and a time slot therein, that is optimal for scheduling a particular event. For instance, in a first exemplary situation, a user may provide a query to the calendaring application inquiring about when their next free weekend is that they may be to schedule a particular event. The calendaring application may analyze the context of the query to identify characteristics associated with the event (e.g., event details such as event length, event location, event activity, etc. may be deduced). These details may have been previously provided by a user (e.g., during an event creation process). Alternatively, the application may be able to dynamically infer some or all of these details based on various factors (e.g., prior iterations of the same type of event, data associated with the event type acquired from other sources, etc.). Utilizing these details, the application may dynamically find a day and time that would accommodate this event. In an aspect, to facilitate this finding, the application may consider certain associated metrics such as average travel time to and back from the event, weather data (if available), traffic data (if available), and the like. Upon identifying a day and time slot for the event, the application may notify the user and inquire whether the proposed day and time is satisfactory for the user. Responsive to receiving user confirmation, the application may proceed with scheduling the event for the proposed day and time.

In a second exemplary situation, a user may inquire about the optimal day and time that a particular person, or group of people, could visit their home. For instance, a user may inquire about the optimal weekend that their grandparents could visit their home to spend time with the kids. Responsive to receiving this query, the application may first identify a user's availability during all upcoming weekends in a predetermined upcoming time window (e.g., over the next week, month, 3 months, etc.). The application may then present all available times to the user for when they had time for this visit to occur. If available, the application may leverage additional information associated with the user or their family (e.g., their age, preferences, physical capabilities, available travel means, etc.) to determine an optimal visiting time. For instance, if two possible time windows are identified, but one of the time windows would require the grandparents to travel home at night, then the application may dynamically select, or suggest, the other time window to minimize the stress of travel on the user's grandparents. Similar decisions may be made with respect to weather (e.g., select a day/time that avoids inclement weather travel), traffic (e.g., select a day/time with less traffic on the road), and other considerations if the appropriate data is available to the system.

In a third exemplary situation, a user may inquire about the optimal day and time that they could visit a particular location with a specific group of people. For instance, a user may inquire about the optimal weekend that their family could visit a theme park. Responsive to receiving this query, the application may access calendar information associated with each member of the user's family to identify an available weekend day and time that the family is collectively able to attend the theme park. The application may further tailor this search by leveraging additional data (e.g., traffic information, weather information, historical theme park attendance information, theme park operational announcements, theme park event announcements, etc.), if available, to identify an optimal day and time from a plurality of available days and times. For instance, although the application identifies several weekends that the entire family may be free to visit a theme park, the application may dynamically suggest that the family visit the theme park during the weekend that historically has the lowest attendance.

It should be understood that embodiments in this disclosure are exemplary only, and that other embodiments may include various combinations of features, as well as additional or fewer features, may be utilized. For example, some calendaring applications may leverage all of the concepts associated with “layers,” “tags,” “lenses,” “rules,” and “metrics,” whereas other calendaring applications may incorporate some subset of the foregoing features.

In general, any process or operation discussed in this disclosure that is understood to be computer-implementable may be performed by one or more processors of a computer system, such as any of the systems or devices in system 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as system environment 100, may include one or more computing devices. If the one or more processors of the computer system are implemented as a plurality of processors, the plurality of processors may be included in a single computing device or distributed among a plurality of computing devices. If a system environment comprises a plurality of computing devices, the memory of the computer system may include the respective memory of each computing device of the plurality of computing devices.

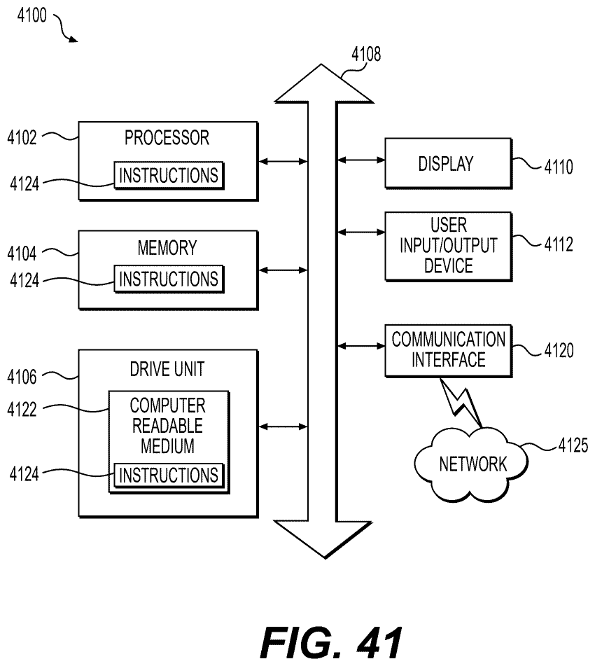

FIG. 41 is a simplified functional block diagram of a computer system 4100 that may be configured as a computing device for executing the processes described herein, according to exemplary embodiments of the present disclosure. In various embodiments, any of the systems herein may be an assembly of hardware including, for example, a data communication interface 4120 for packet data communication. The platform also may include a central processing unit (“CPU”) 4102, in the form of one or more processors, for executing program instructions. The platform may include an internal communication bus 4108, and a storage unit 4106 (such as ROM, HDD, SDD, etc.) that may store data on a computer readable medium 4122, although the system 4100 may receive programming and data via network communications via electronic network 4125 (e.g., voice, video, audio, images, or any other data over the electronic network 4125). The system 4100 may also have a memory 4104 (such as RAM) storing instructions 4124 for executing techniques presented herein, although the instructions 4124 may be stored temporarily or permanently within other modules of system 4100 (e.g., processor 4102 and/or computer readable medium 4122). The system 4100 also may include input and output ports 4112 and/or a display 4110 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these apparatuses, devices, systems, or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified by context, any explicit or implicit ordering of steps performed in the execution of a method does not imply that those steps must be performed in the order presented but instead may be performed in a different order or in parallel.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that the disclosed embodiments may be applicable to any environment, such as a desktop or laptop computer, a laboratory computing system, an office computing environment, etc. Also, the disclosed embodiments may be applicable to any type of Internet protocol.

It should be appreciated that in the above description of exemplary embodiments of the disclosure, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of this disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of this disclosure, and it is intended to claim all such changes and modifications as falling within the scope of this disclosure. For example, functionality may be added or deleted from the various calendaring interface and operations may be interchanged between them. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for managing an event on a data organizer application, the computer-implemented method comprising:
receiving, using a processor associated with the data organizer application, a selection from a user to transition an interface of an electronic data organizer of the data organizer application from a first view to a second view;
identifying, using the processor, a type designation associated with each event contained in the electronic data organizer; and
reorganizing, using the processor and based on the selection, a visual display of each event of the interface to correspond with the second view as dictated by the type designation.

2. The computer-implemented method of claim 1, wherein the receiving the selection comprises detecting user interaction with a digital slider presented on the interface.

3. The computer-implemented method of claim 1, wherein the first view is a default view and wherein the second view is a month view or a weekend view.

4. The computer-implemented method of claim 3, wherein when the second view is the month view, the electronic data organizer comprises a plurality of standard week rows and an expanded week row.

5. The computer-implemented method of claim 4, wherein each day in the expanded week row data is configured to present more event data than in the plurality of standard week rows.

6. The computer-implemented method of claim 3, wherein when the second view is the weekend view, the electronic data organizer comprises a first section and a second section;
wherein the first section displays a listing of a plurality of temporally associated weekends; and
wherein the second section displays event data for each weekend day of a selected weekend.

7. The computer-implemented method of claim 6, wherein the data organizer application enables vertical scrolling functionality in the first section and horizontal scrolling functionality in the second section.

8. The computer-implemented method of claim 1, further comprising:
receiving a selection for a day within the electronic data organizer; and
generating a popup screen that comprises event information for each of the events occurring in the day.

9. The computer-implemented method of claim 1, further comprising:
detecting a selection of a tag within a tag bar associated with a navigation pane of the electronic data organizer;
identifying each relevant event corresponding to the tag; and
visually distinguishing each relevant event associated with the selected tag in the electronic data organizer.

10. The computer-implemented method of claim 9, further comprising:
providing a mini-calendar that is co-displayed with the electronic data organizer, wherein the mini-calendar is divided into a plurality of sections and wherein each of the plurality of sections corresponds to a month of a year;
identifying a number of the relevant events that occur in each of the plurality of sections; and
presenting an indication of the number of the relevant events within each of the plurality of sections in the mini-calendar.

11. A computer system, comprising:
at least one processor;
at least one memory storing instructions that are executable by the at least one processor, wherein the instructions cause the at least one processor to:
receive a selection from a user to transition an interface of an electronic data organizer of a data organizer application from a first view to a second view;
identify a type designation associated with each event contained in the electronic data organizer; and
reorganize, based on the selection, a visual display of each event of the interface to correspond with the second view as dictated by the type designation.

12. The computer system of claim 11, wherein the instructions to receive the selection comprise instructions to:
detect user interaction with a digital slider presented on the interface.

13. The computer system of claim 11, wherein the first view is a default view and wherein the second view is a month view or a weekend view.

14. The computer system of claim 13, wherein when the second view is the month view, the electronic data organizer comprises a plurality of standard week rows and an expanded week row.

15. The computer system of claim 14, wherein each day in the expanded week row data is configured to present more event data than in the plurality of standard week rows.

16. The computer system of claim 13, wherein when the second view is the weekend view, the electronic data organizer comprises a first section and a second section;
wherein the first section displays a listing of a plurality of temporally associated weekends; and
wherein the second section displays event data for each weekend day of a selected weekend.

17. The computer system of claim 16, wherein the data organizer application enables vertical scrolling functionality in the first section and horizontal scrolling functionality in the second section.

18. The computer system of claim 11, wherein the instructions are further executable by the at least one processor to:
detect a selection of a tag within a tag bar associated with a navigation pane of the electronic data organizer;
identify each relevant event corresponding to the tag; and
visually distinguish each relevant event associated with the selected tag in the electronic data organizer.

19. The computer system of claim 18, wherein the instructions are further executable by the at least one processor to:
provide a mini-calendar that is co-displayed with the electronic data organizer, wherein the mini-calendar is divided into a plurality of sections and wherein each of the plurality of sections correspond to a month of a year;
identify a number of the relevant events that occur in each of the plurality of sections; and
present an indication of the number of the relevant events within each of the plurality of sections in the mini-calendar

20. A non-transitory computer-readable medium storing instructions for managing an event on a data organizer application, the instructions, when executed by at least one processor, causing the at least one processor to perform operations comprising:
receiving a selection from a user to transition an interface of an electronic data organizer of the data organizer application from a first view to a second view;
identifying a type designation associated with each event contained in the electronic data organizer; and
reorganizing, based on the selection, a visual display of each event of the interface to correspond with the second view as dictated by the type designation.
